(19) United States
(12) Patent Application Publication
(10) Pub. No.: US 2026/0211747 A1
(43) Pub. Date: Jul. 23, 2026

(54) RESOURCE SCHEDULING METHOD AND RELATED APPARATUS, ELECTRONIC DEVICE, MEDIUM, AND PROGRAM PRODUCT

(71) Applicant: TENCENT TECHNOLOGY (SHENZHEN) COMPANY LIMITED, Shenzhen (CN)

(72) Inventors: Qianren LU, Shenzhen (CN); Ben MA, Shenzhen (CN); Xingjun LAI, Shenzhen (CN); Wenxuan JIA, Shenzhen (CN); Fu WANG, Shenzhen (CN)

(21) Appl. No.: 19/360,964

(22) Filed: Oct. 16, 2025

Related U.S. Application Data
(63) Continuation of application No. PCT/CN2024/107471, filed on Jul. 25, 2024.

(30) Foreign Application Priority Data
Sep. 18, 2023 (CN) 202311200403.6

(51) Int. Cl. G06F 9/50; G06F 9/48

(52) U.S. Cl. CPC G06F 9/5083; G06F 9/4881

(57) ABSTRACT

The present disclosure provides a resource scheduling method and related electronic device. The resource scheduling method includes obtaining a plurality of candidate resource combinations corresponding to the target task in response to a resource scheduling request of a target task, each candidate resource combination comprising at least one target resource needed by the target task and a target resource quantity of the target resource; searching resource pools in a multi-level resource pool in ascending order based on preset levels in the multi-level resource pool to determine seed resource pools corresponding to the candidate resource combinations for each candidate resource combination based on the at least one target resource and the target resource quantity; and determining a target resource pool used to satisfy the resource scheduling request in the plurality of seed resource pools based on levels of the seed resource pools corresponding to the candidate resource combinations.

### RELATED APPLICATIONS

This application is a continuation of PCT Application No. PCT/CN2024/107471, filed on Jul. 25, 2024, which in turn claims priority to Chinese Patent Application No. 2023112004036, filed with the China National Intellectual Property Administration on Sep. 18, 2023, and entitled “RESOURCE SCHEDULING METHOD AND RELATED APPARATUS, ELECTRONIC DEVICE, AND MEDIUM”, which are incorporated herein by reference in their entirety.

### FIELD OF THE TECHNOLOGY

The present disclosure relates to the field of network technologies, and in particular, to resource scheduling.

### BACKGROUND OF THE DISCLOSURE

Resource scheduling usually needs to be processed in an era in which internet of things is accompanied with the development of network technologies year by year. When resource scheduling is performed, a resource that needs to be used may need to be selected and configured from a plurality of resource pools of different types and different storage conditions, to obtain a plurality of candidate resource configuration solutions, and then a solution satisfying a requirement is selected from the candidate resource configuration solutions to implement resource scheduling.

Often, a resource scheduling method for configuring a resource scheduling solution based on a plurality of candidate resource pools mainly includes forming, based on a preset event template, a resource scheduling solution matching the preset event template and the like.

Because the preset event template cannot be applied to various application scenarios, such a method has poor flexibility and adaptability.

### SUMMARY

Embodiments of the present disclosure provide a resource scheduling method and related apparatus, an electronic device, a medium, and a program product, to improve flexibility of resource scheduling and efficiency of resource scheduling.

According to an aspect of the present disclosure, a resource scheduling method is provided, including obtaining a plurality of candidate resource combinations corresponding to the target task in response to a resource scheduling request of a target task, each candidate resource combination comprising at least one target resource needed by the target task and a target resource quantity of the target resource; searching resource pools in a multi-level resource pool in ascending order based on preset levels in the multi-level resource pool to determine seed resource pools corresponding to the candidate resource combinations for each candidate resource combination based on the at least one target resource and the target resource quantity; and determining a target resource pool used to satisfy the resource scheduling request in the plurality of seed resource pools based on levels of the seed resource pools corresponding to the candidate resource.

According to an aspect of the present disclosure, an electronic device is provided. The electronic device includes a memory and a processor, the memory having a computer program stored therein, and the processor, when executing the computer program, implementing the resource scheduling method described above.

According to an aspect of the present disclosure, a non-transitory computer-readable storage medium is provided, the storage medium having a computer program stored therein, the computer program, when executed by a processor, implementing the resource scheduling method described above.

In the embodiments of the present disclosure, in the resource scheduling method, in response to a resource scheduling request of a target task, a plurality of candidate resource combinations corresponding to the target task are obtained, each candidate resource combination including at least one target resource needed by the target task and a target resource quantity of the target resource. Then, for each candidate resource combination based on the at least one target resource and the target resource quantity, a multi-level resource pool is searched in ascending order of levels, to determine seed resource pools corresponding to the candidate resource combinations. Therefore, a series of corresponding seed resource pools may be determined in each candidate resource combination corresponding to the target task. Further, a target resource pool used to satisfy the resource scheduling request is determined in the plurality of seed resource pools based on levels of the seed resource pools corresponding to the candidate resource combinations. Because in the resource scheduling method in the present disclosure, the target resource pool used to satisfy the resource scheduling request is determined based on the levels of the seed resource pools corresponding to the candidate resource combinations, the resource scheduling request of the target task is responded to at a rapid speed. Accordingly, the efficiency of resource scheduling can be improved. The foregoing solution does not limit what tasks and what candidate resource combinations need to be aimed at. Therefore, the solution can be applied to various application scenarios, and the target resource pool used to satisfy the resource scheduling request is properly determined. Therefore, the flexibility of resource scheduling is high.

Other features and advantages of the present disclosure will be set forth in the following specification, and will partially become apparent in the specification, or can be learned by implementing embodiments of the present disclosure. Objectives and other advantages of the present disclosure can be achieved and acquired through structures particularly indicated in the specification, the claims, and the accompanying drawings.

### BRIEF DESCRIPTION OF THE DRAWINGS

FIG. 1 is an architecture diagram of a system to which a resource scheduling method is applied according to an embodiment of the present disclosure;

FIG. 2A to FIG. 2C are diagrams of a corresponding front-end interface when a resource scheduling method according to an embodiment of the present disclosure is applied to virtual resource scheduling;

FIG. 2D to FIG. 2F are diagrams of a corresponding front-end interface when a resource scheduling method according to an embodiment of the present disclosure is applied to physical resource scheduling;

FIG. 3 is an overall flowchart of a resource scheduling method according to an embodiment of the present disclosure;

FIG. 4A is a diagram of obtaining a candidate resource combination in a resource scheduling method according to an embodiment of the present disclosure;

FIG. 4B is a diagram of determining a seed resource pool during virtual resource scheduling according to an embodiment of the present disclosure;

FIG. 4C is a diagram of determining a seed resource pool during physical resource scheduling according to an embodiment of the present disclosure;

FIG. 4D is a diagram of determining a target resource pool according to an embodiment of the present disclosure;

FIG. 5 is a specific flowchart of operation 320 in FIG. 3;

FIG. 6 is a diagram of determining a seed resource pool based on a single general type according to an embodiment of the present disclosure;

FIG. 7 is a specific flowchart of operation 520 in FIG. 5;

FIG. 8 is a specific flowchart of operation 720 in FIG. 7;

FIG. 9 is a diagram of searching a multi-level resource pool according to an embodiment of the present disclosure;

FIG. 10 is a specific flowchart of operation 820 in FIG. 8;

FIG. 11A to FIG. 11D are diagrams of determining a scheduling return amount of a resource pool to be checked according to an embodiment of the present disclosure;

FIG. 12 is an example specific flowchart of operation 1060 in FIG. 10;

FIG. 13 is a diagram of determining a scheduling return amount according to an embodiment of the present disclosure;

FIG. 14 is a specific flowchart of operation 320 in FIG. 3;

FIG. 15A and FIG. 15B are diagrams of determining a seed resource pool based on a deficit quantity according to an embodiment of the present disclosure;

FIG. 16 is a specific flowchart of performing a second process after operation 1420 in FIG. 14 according to an embodiment of the present disclosure;

FIG. 17 is a specific flowchart of operation 330 in FIG. 3;

FIG. 18 is a specific flowchart of operation 1720 in FIG. 17;

FIG. 19 is a diagram of determining a target resource pool according to an embodiment of the present disclosure;

FIG. 20 a specific flowchart of operation 330 in FIG. 3;

FIG. 21 is a diagram of determining a target resource pool according to an embodiment of the present disclosure;

FIG. 22 is a specific flowchart of operation 300 in FIG. 3;

FIG. 23 is a specific flowchart of operation 2200 in FIG. 22;

FIG. 24 is a specific flowchart of supplementing a resource to a multi-level resource pool according to an embodiment of the present disclosure;

FIG. 25 is a specific flowchart of operation 2440 in FIG. 24;

FIG. 26 is a diagram of supplementing a resource to a multi-level resource pool according to an embodiment of the present disclosure;

FIG. 27 is a specific flowchart of selecting a target computing node from a plurality of candidate computing nodes;

FIG. 28 is a specific flowchart of operation 300 in FIG. 3;

FIG. 29 is a specific flowchart of operation 2840 in FIG. 28;

FIG. 30 is a diagram of a type of system architecture to which a resource scheduling method according to an embodiment of the present disclosure is applied;

FIG. 31 is a diagram of an asynchronous operation on a resource scheduling control layer in a resource scheduling system architecture according to an embodiment of the present disclosure;

FIG. 32 is a diagram of a resource scheduling method according to an embodiment of the present disclosure;

FIG. 33 is a block diagram of a resource scheduling apparatus according to an embodiment of the present disclosure;

FIG. 34 is a structural diagram of a terminal implementing the resource scheduling method shown in FIG. 3 according to an embodiment of the present disclosure; and

FIG. 35 is a structural diagram of a server implementing the resource scheduling method shown in FIG. 3 according to an embodiment of the present disclosure.

### DESCRIPTION OF EMBODIMENTS

To make objectives, technical solutions, and advantages of the present disclosure clearer, the present disclosure will be further described below in detail with reference to accompanying drawings and embodiments. Specific embodiments described herein are merely used to explain the present disclosure rather than limit the present disclosure.

Before the embodiments of the present disclosure are further described in detail, the nouns and terms involved in the embodiments of the present disclosure are described. The nouns and terms involved in the embodiments of the present disclosure are suitable to explain as follows:

A target task refers to a task that needs to be executed as a target in various service scenarios. To normally execute the target task, the target task has a corresponding resource scheduling request, and the resource scheduling request is used to schedule a resource needed by normal execution of the target task.

A candidate resource combination is used to represent a target resource and a target resource quantity that are needed for executing the target task.

A resource pool is a set of available resources in an organization or system. These resources may be material resources, may be computer computing power, or may be a set of hardware and software resources or other types of resources that may be used by a program in a computer system.

In the related art, for a requirement of resource scheduling, a resource scheduling method for configuring a resource scheduling solution based on a plurality of candidate resource pools mainly includes, for example, forming, based on a preset event template, a resource scheduling solution matching the preset event template, a resource scheduling solution of performing solving based on a genetic algorithm, and the like. In the previous method, because the preset event template cannot be applied to various application scenarios, the method has poor flexibility and adaptability. In the latter method, the genetic algorithm relies on a large quantity of samples to perform training, time costs are high and resource allocation efficiency is low.

To this end, the present disclosure provides a resource scheduling method, which can be applied to various application scenarios, a target resource pool used to satisfy a resource scheduling request is properly determined, and flexibility of resource scheduling is high.

### A System Architecture Applied to the Embodiments of the Present Disclosure and Descriptions of a Scenario.

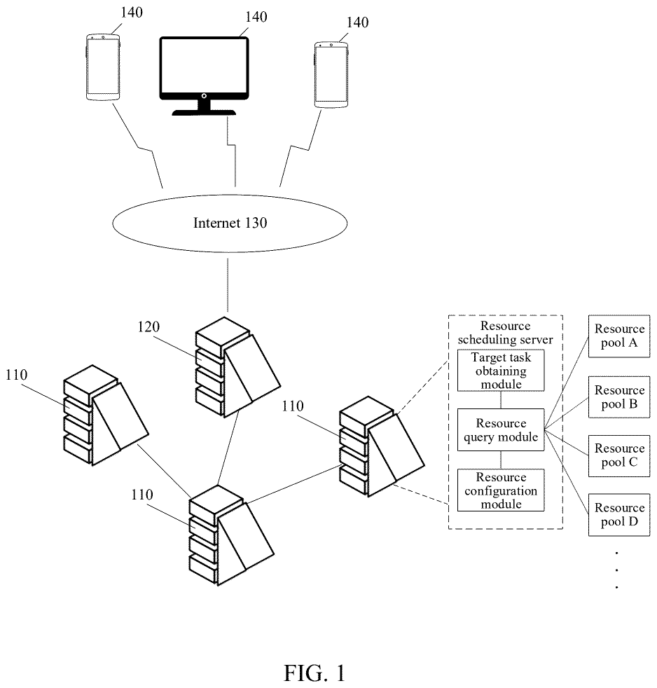

FIG. 1 is an architecture diagram of a system to which a resource scheduling method is applied according to an embodiment of the present disclosure. The system includes a terminal 140, internet 130, a gateway 120, a resource scheduling server 110, and the like.

The terminal 140 is a device configured to display an input box, input information, and a candidate word. The system includes a plurality of forms such as a desktop computer, a notebook computer, a tablet computer, a personal digital assistant (PDA), a mobile phone, and a vehicle-mounted terminal. In addition, the system may be a single device, or may be a set of combinations of a plurality of devices. For example, the plurality of devices are connected through a local area network, and collaboratively operate by sharing one display device, to jointly form the terminal 140. The terminal 140 may also communicate with the internet 130 in a wired or wireless manner, to exchange data.

The resource scheduling server 110 is a computer system that can implement resource scheduling based on a target task. Compared with the common terminal 140, the resource scheduling server 110 has excessively high requirements in aspects such as stability, security, and performance. The resource scheduling server 110 may be a high-performance computer, a cluster of a plurality of high-performance computers, a part (for example, a virtual machine) spared from a high-performance computer, a combination of a part (for example, a virtual machine) spared from a plurality of high-performance computers, or the like in a network platform. The resource scheduling server 110 includes a target task obtaining module, a resource querying module, and a resource configuration module. The target task obtaining module is configured to: obtain a target task that needs to be executed in a current service scenario, and parse out a resource scheduling request corresponding to the target task. The resource querying module is configured to query, based on the resource scheduling request, a plurality of resource pools for a target resource pool matching the plurality of resource pools. The resource configuration module is configured to configure, after the target resource pool matching the resource scheduling request is determined, a target resource in the target resource pool for the target task that needs to be executed, to complete resource scheduling.

The gateway 120 is also referred to as an inter-network connector or a protocol converter. The gateway implements network interconnection on a transport layer, and is a computer system or a device that performs a conversion function. The gateway is a translator between two systems that use different communication protocols, data formats, or languages, or even completely different architectures. In addition, the gateway may also provide filtering and security functions.

A message transmitted by the terminal 140 to the resource scheduling server 110 needs to be transmitted to the corresponding resource scheduling server 110 through the gateway 120. A message transmitted by the resource scheduling server 110 to the terminal 140 also needs to be transmitted to the corresponding terminal 140 through the gateway 120. The terminal 140 may be configured to deliver the target task to the resource scheduling server through the internet 130 and the gateway 120.

The embodiments of the present disclosure are applicable to a plurality of types of service scenarios. In different service scenarios, meanings of the target task, the target resource, the candidate resource combination, and the resource pool are different. Two types of service scenarios are selected below for description.

In an embodiment of one type of service scenario, when the target task relates to virtual resource scheduling, for example, to construct an application, code blocks need to be invoked from different data storage modules. In this type of service scenario, a related target task may be “constructing an application”, a related target resource may be “a code block”, a related resource pool may be “a data storage module storing a code block”, and a candidate resource combination may be “a candidate code block combination A, a candidate code block combination B, and a candidate code block combination C that are needed for constructing an application”.

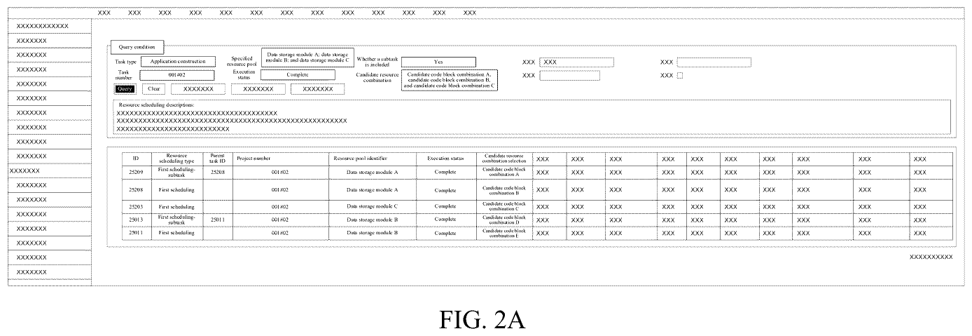

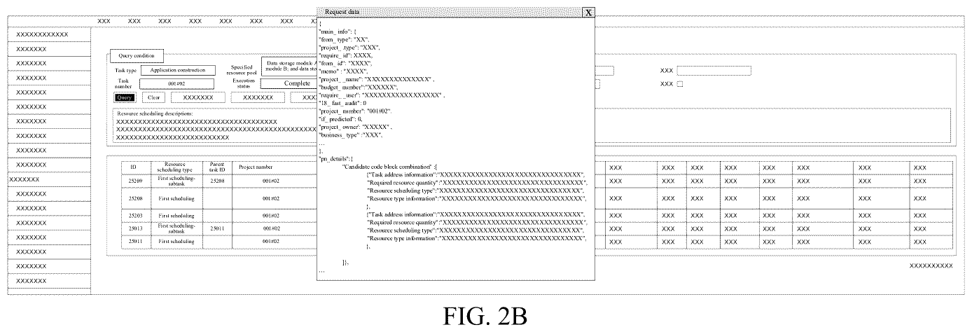

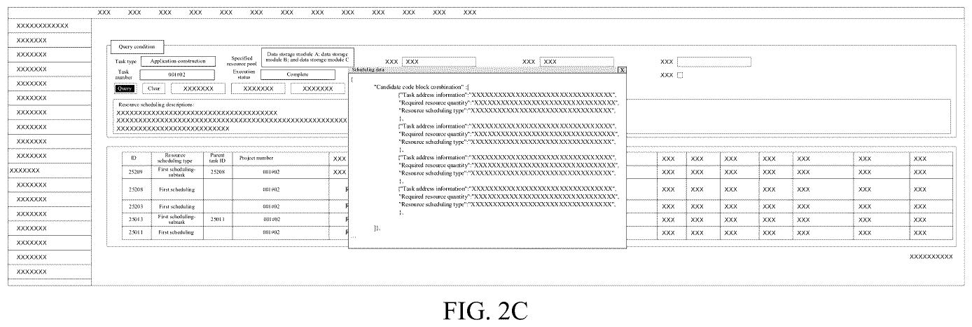

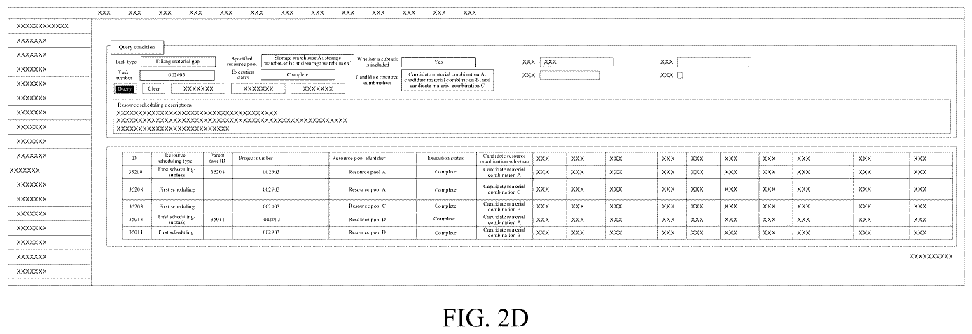

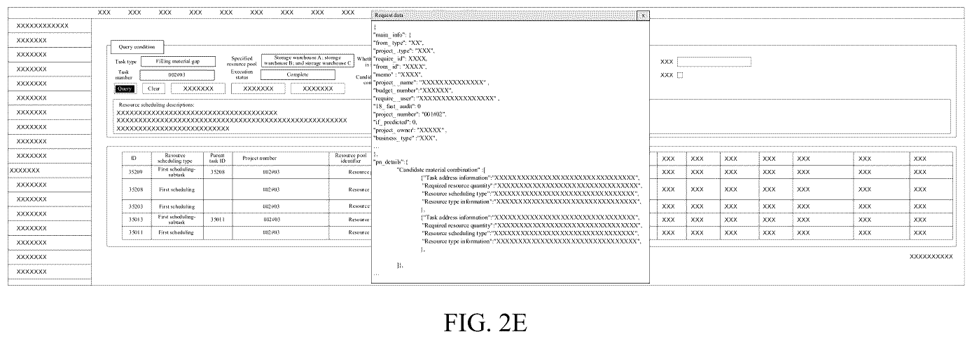

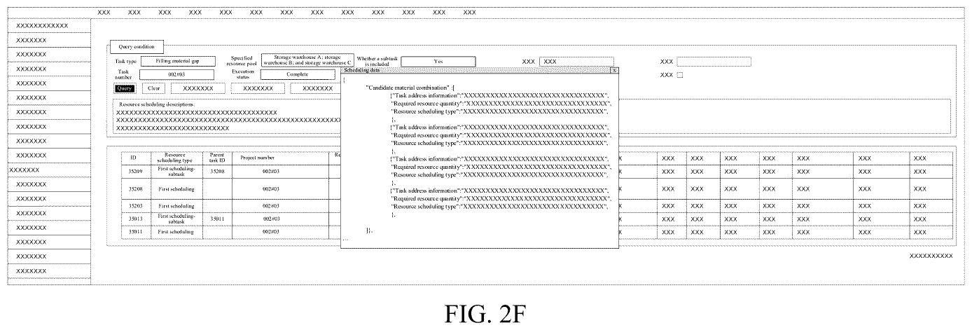

FIG. 2A shows related record information of each code block scheduled based on application construction when the target task relates to virtual resource scheduling. To query related record information of scheduling each code block based on application construction, a query condition needs to be input. In the query condition, a field of a “task type” is used to be filled by a type of a target task that needs to be queried, namely, “application construction” in this embodiment. A field of a “specified resource pool” is used to be filled by a resource pool that needs to be specified for resource scheduling, namely, “a data storage module A, a data storage module B, and a data storage module C” in this embodiment. A field of a “task number” is used to be filled by a number of a target task that needs to be queried, namely, “001#02” in this embodiment. A field of an “execution status” is used to be filled by an execution status corresponding to a target task that needs to be queried, namely, a target task in a “complete” state that needs to be queried in this embodiment. A field of “whether a subtask is included” is used to be filled by whether a subtask corresponding to a main task is displayed in a target task that needs to be queried. In this embodiment, “yes” is filled in, namely, related record information corresponding to the subtask that needs to be displayed. A field of a “candidate resource combination” is used to be filled by a candidate resource combination that needs to be used as a resource scheduling reference, namely, “a candidate code block combination A {[code block A, 1]; [code block C, 3]; and [code block F, 4]}, a candidate code block combination B {[code block B, 2]; [code block D, 2]; and [code block F, 4]}, and a candidate code block combination C {[code block A, 5]; [code block E, 3]; and [code block F, 2]}” in this embodiment. A field of “resource scheduling descriptions” is used to be filled by description content related to resource scheduling. A field type in the query condition and a fillable content type are diversified, and are not listed one by one herein.

FIG. 2B shows request data used for performing resource scheduling of a code block type for constructing an application when a target task relates to virtual resource scheduling. In the request data, for resource scheduling of the code block type in this case, information needed by each associated resource scheduling request is recorded, for example, associated data such as task address information corresponding to the target task, a required resource quantity for resource scheduling of the code block type, a resource scheduling type and resource type information of this scheduling are recorded when resource scheduling is performed based on each candidate code block combination and based on the resource scheduling request. Specifically, when the target resource is a code block, the resource scheduling type may be a type representing code block scheduling such as an “integral code block” or a “code block fragment statement”, and the resource type information may be descriptions of a code block function, descriptions of code block adaptation information, or the like.

The embodiment shown in FIG. 2B is only an example, and content related to request data in an a specific application may include, but is not limited to, the foregoing specific embodiments listed above.

FIG. 2C shows scheduling data used for performing resource scheduling of a code block type for constructing an application when a target task relates to virtual resource scheduling. In the scheduling data, for resource scheduling of the code block type in this case, associated detailed information recorded after resource scheduling that is performed is recorded, for example, associated data such as task address information corresponding to the target task, a required resource quantity for resource scheduling of the code block type, a resource scheduling type and resource type information of this scheduling in a process in which resource scheduling is performed based on each candidate code block combination.

The embodiment shown in FIG. 2C is only an example, and content related to scheduling data in an a specific application may include, but is not limited to, the foregoing specific embodiments listed above.

In an embodiment of the other type of service scenario, when the target task relates to physical resource scheduling, for example, to satisfy a material requirement, materials are scheduled from storage warehouses at various places. In this type of service scenario, a related target task may be “satisfying a material requirement”, a related target resource may be “a material”, a related resource pool may be “a storage warehouse in which a material is stored”, and a candidate resource combination may be “a material A, a material B, and a material C that are needed to fill a material gap”.

FIG. 2D shows related record information of scheduling stored materials in various storage warehouses based on filling a material gap when the target task relates to physical resource scheduling. To query related record information of scheduling each material based on filling a material gap, a query condition needs to be input. In the query condition, a field of a “task type” is used to be filled by a type of a target task that needs to be queried, namely, “filling a material gap” in this embodiment. A field of a “specified resource pool” is used to be filled by a resource pool that needs to be specified for resource scheduling, namely, “a storage warehouse A, a storage warehouse B, and a storage warehouse C” in this embodiment. A field of a “task number” is used to be filled by a number of a target task that needs to be queried, namely, “002#03” in this embodiment. A field of an “execution status” is used to be filled by an execution status corresponding to a target task that needs to be queried, namely, a target task in a “complete” state that needs to be queried in this embodiment. A field of “whether a subtask is included” is used to be filled by whether a subtask corresponding to a main task is displayed in a target task that needs to be queried. In this embodiment, “yes” is filled in, namely, related record information corresponding to the subtask that needs to be displayed. A field of a “candidate resource combination” is used to be filled by a candidate resource combination that needs to be used as a resource scheduling reference, namely, “a candidate material combination A {[material A, 33]; [material C, 45]; and [material F, 48]}, a candidate material combination B {[material A, 47]; [material C, 56]; and [material F, 78]}, and a candidate material combination C {[material A, 34]; [material C, 45]; and [material F, 69]}” in this embodiment. A field of “resource scheduling descriptions” is used to be filled by description content related to resource scheduling. A field type in the query condition and a fillable content type are diversified, and are not listed one by one herein.

FIG. 2E shows request data used for performing resource scheduling of a material type for constructing an application when the target task relates to physical resource scheduling. In the request data, for resource scheduling of the material type in this case, information needed by each associated resource scheduling request is recorded, for example, associated data such as task address information corresponding to the target task, a required resource quantity for resource scheduling of the material type, a resource scheduling type and resource type information of this scheduling are recorded when resource scheduling is performed based on each candidate material combination and based on the resource scheduling request. Specifically, when the target resource is a material, the resource scheduling type may be a type representing material scheduling such as an “an entire box of materials”, “separate materials”, or “a material component”, and the resource type information may be descriptions of a material function, descriptions of material adaptation information, or the like.

The embodiment shown in FIG. 2E is only an example, and content related to request data in an a specific application may include, but is not limited to, the foregoing specific embodiments listed above.

FIG. 2F shows scheduling data used for performing resource scheduling of a material type for constructing an application when the target task relates to physical resource scheduling. In the scheduling data, for resource scheduling of the material type in this case, associated detailed information recorded after resource scheduling that is performed is recorded, for example, associated data such as task address information corresponding to the target task, a required resource quantity for resource scheduling of the material type, a resource scheduling type and resource type information of this scheduling in a process in which resource scheduling is performed based on each candidate material combination.

The embodiment shown in FIG. 2F is only an example, and content related to scheduling data in an a specific application may include, but is not limited to, the foregoing specific embodiments listed above.

The embodiments of the present disclosure may be applied to various service scenarios, which may include, but are not limited to, the specific embodiments listed above.

### GENERAL DESCRIPTIONS OF EMBODIMENTS OF THE PRESENT DISCLOSURE

The embodiments of the present disclosure are applicable to a plurality of types of service scenarios. In different service scenarios, meanings of the target task, the target resource, the candidate resource combination, and the resource pool are different. When the target task relates to virtual resource scheduling, for example, to construct an application, code blocks need to be invoked from different data storage modules. In this type of service scenario, a related target task may be “constructing an application”, a related target resource may be “a code block”, a related resource pool may be “a data storage module storing a code block”, and a candidate resource combination may be “a candidate code block combination A, a candidate code block combination B, and a candidate code block combination C that are needed for constructing an application”. When the target task relates to physical resource scheduling, for example, to satisfy a material requirement, materials are scheduled from storage warehouses at various places. In this type of service scenario, a related target task may be “satisfying a material requirement”, a related target resource may be “a material”, a related resource pool may be “a storage warehouse in which a material is stored”, and a candidate resource combination may be “a material A, a material B, and a material C that are needed to fill a material gap”. The embodiments of the present disclosure may be applied to various service scenarios, which may include, but are not limited to, the specific embodiments listed above.

### Detailed Descriptions of Operation 300

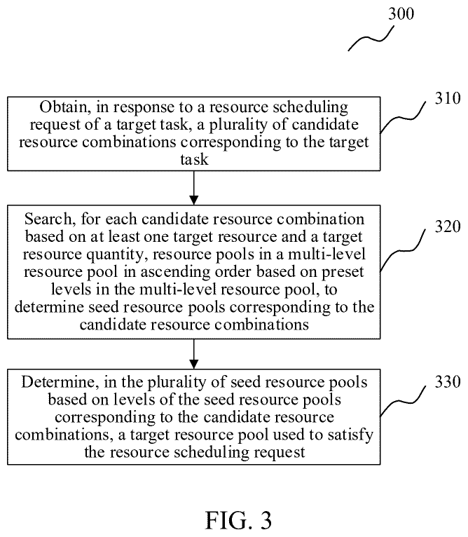

Referring to FIG. 3, a resource scheduling method in an embodiment of the present disclosure may be performed by the resource scheduling server 110, and includes, but is not limited to, the following operation 310 to operation 330.

Operation 310: Obtain, in response to a resource scheduling request of a target task, a plurality of candidate resource combinations corresponding to the target task, where each candidate resource combination includes at least one target resource needed by the target task and a target resource quantity of the target resource.

Operation 320: Search, for each candidate resource combination based on the at least one target resource and the target resource quantity, resource pools in a multi-level resource pool in ascending order based on preset levels in the multi-level resource pool, to determine seed resource pools corresponding to the candidate resource combinations.

Operation 330: Determine, in the plurality of seed resource pools based on levels of the seed resource pools corresponding to the candidate resource combinations, a target resource pool used to satisfy the resource scheduling request.

Operation 310 to operation 330 are described in detail below.

In operation 310, in response to the resource scheduling request of the target task, the plurality of candidate resource combinations corresponding to the target task are obtained, where each candidate resource combination includes the at least one target resource needed by the target task and the target resource quantity of the target resource. The target task refers to a task that needs to be executed as a target in various service scenarios. To normally execute the target task, the target task has a corresponding resource scheduling request, and the resource scheduling request is used to schedule a resource needed by normal execution of the target task. Therefore, to schedule the corresponding resource for the target task, and in response to the resource scheduling request of the target task, a plurality of candidate resource combinations corresponding to the target task need to be obtained. Each candidate resource combination includes at least one target resource needed by the target task and a target resource quantity of the target resource. The target resource quantity is used to identify a resource quantity of a corresponding target resource. For example, there are three types of target resources: a target resource quantity of a target resource 1 is 10, a target resource quantity of a target resource 2 is 15, and a target resource quantity of a target resource 3 is 30.

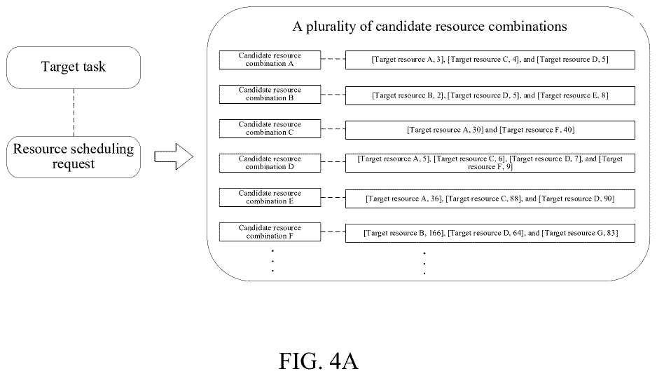

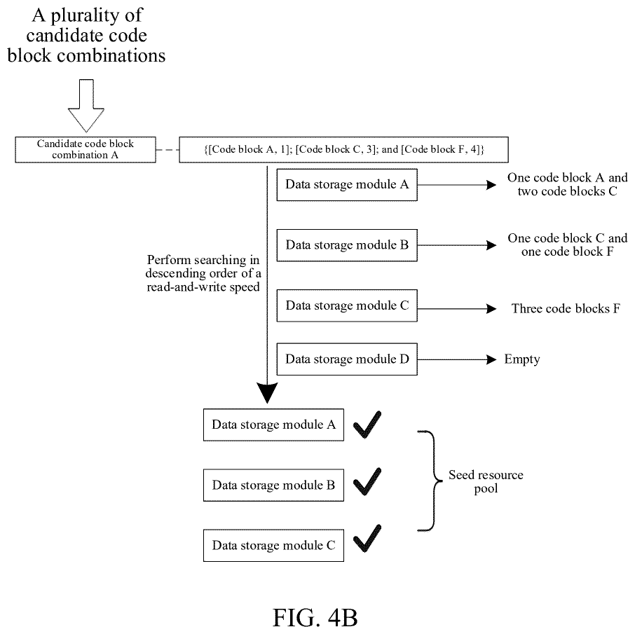

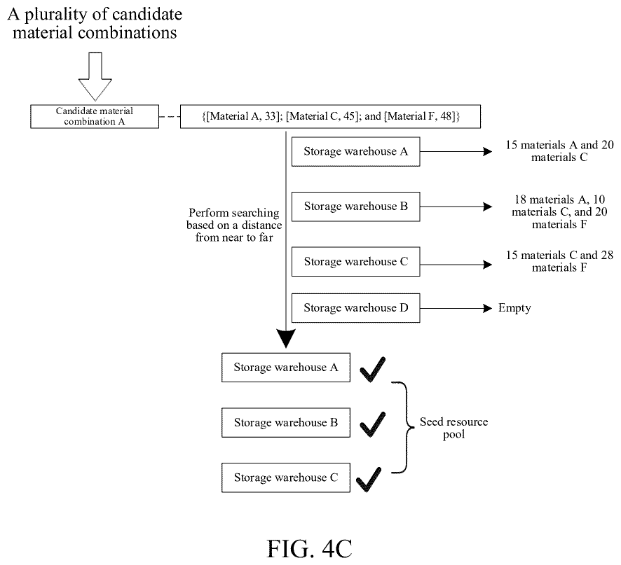

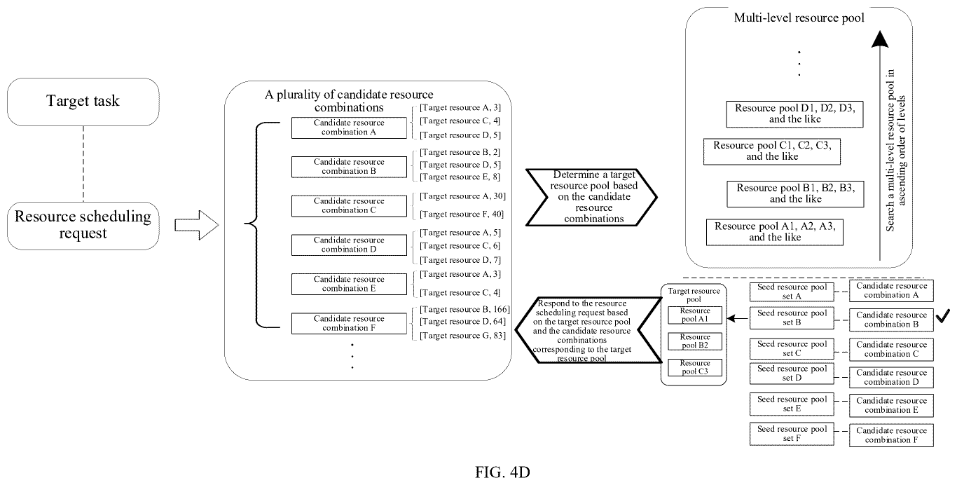

Referring to a diagram of a resource scheduling request shown in FIG. 4A, various candidate resource combinations can be obtained in response to the resource scheduling request for the target task.

A “candidate resource combination A” includes {[target resource A, 3], [target resource C, 4], and [target resource D, 5]} that are needed by the target task, a target resource quantity corresponding to the target resource A is 3, a target resource quantity corresponding to the target resource C is 4, and a target resource quantity corresponding to the target resource D is 5.

A “candidate resource combination B” includes {[target resource B, 2], [target resource D, 5], and [target resource E, 8]} that are needed by the target task, a target resource quantity corresponding to the target resource B is 2, a target resource quantity corresponding to the target resource D is 5, and a target resource quantity corresponding to the target resource E is 8.

A “candidate resource combination C” includes {[target resource A, 30] and [target resource F, 40]} that are needed by the target task, a target resource quantity corresponding to the target resource A is 30, and a target resource quantity corresponding to the target resource F is 40.

A “candidate resource combination D” includes {[target resource A, 5], [target resource C, 6], [target resource D, 7], and [target resource F, 9]} that are needed by the target task, a target resource quantity corresponding to the target resource A is 5, a target resource quantity corresponding to the target resource C is 6, a target resource quantity corresponding to the target resource D is 7, and a target resource quantity corresponding to the target resource F is 9.

A “candidate resource combination E” includes {[target resource A, 36], [target resource C, 88], and [target resource D, 90]} that are needed by the target task, a target resource quantity corresponding to the target resource A is 36, a target resource quantity corresponding to the target resource C is 88, and a target resource quantity corresponding to the target resource D is 90.

A “candidate resource combination F” includes {[target resource B, 166], [target resource D, 64], and [target resource G, 83]} that are needed by the target task, a target resource quantity corresponding to the target resource B is 166, a target resource quantity corresponding to the target resource D is 64, and a target resource quantity corresponding to the target resource G is 83.

FIG. 4A is used to schematically describe a relationship between the resource scheduling request and the candidate resource combination. In a service scenario of an a specific application, the resource scheduling request and the candidate resource combination may include, but are not limited to, the specific embodiments listed above.

In operation 320, for each candidate resource combination based on the at least one target resource and the target resource quantity, the resource pools in the multi-level resource pool are searched in the ascending order based on the preset levels in the multi-level resource pool, to determine the seed resource pools corresponding to the candidate resource combinations. A resource pool is a set of available resources in an organization or system. These resources may be material resources, may be computer computing power, or may be a set of hardware and software resources or other types of resources that may be used by a program in a computer system. The multi-level resource pool refers to a resource pool with a plurality of different levels. For example, the multi-level resource pool includes three resource pools, and preset levels of the three resource pools are different, or at least some levels of the three resource pools are different.

For each candidate resource combination based on the at least one target resource and the target resource quantity, the multi-level resource pool may be searched in ascending order of levels, to determine the seed resource pools corresponding to the candidate resource combinations. The seed resource pool is a resource pool used to provide a resource that needs to be scheduled for the candidate resource combination.

There may be various rating references for levels of the resource pools, the levels of the resource pools are sorted in ascending order, and overheads caused by resource scheduling of the resource pools sequentially increase. For example, when the target task relates to virtual resource scheduling, levels of data storage modules may be divided based on a read-and-write speed of each data storage module. Accordingly, searching the multi-level resource pool in ascending order of levels is equivalent to searching a multi-level data storage module in descending order of a read-and-write speed, to determine the seed resource pool providing the candidate resource combination with the resource that needs to be scheduled, thereby improving efficiency of resource scheduling. For example, when the target task relates to physical resource scheduling, levels of storage warehouses may be divided based on a distance between each storage warehouse and a material gap. Accordingly, searching the multi-level resource pool in ascending order of levels is equivalent to searching a multi-level storage warehouse based on a distance to the material gap from near to far, to determine the seed resource pool providing the candidate resource combination with the resource that needs to be scheduled, thereby improving efficiency of resource scheduling. The rating reference of the resource pool may include, but is not limited to, the foregoing examples.

Referring to FIG. 4B, in some embodiments, when the target task relates to virtual resource scheduling, for example, to construct an application, code blocks need to be invoked from different data storage modules. In this type of service scenario, the resource pool is “a data storage module storing a code block”, and may specifically include a data storage module A, a data storage module B, and a data storage module C. Levels of data storage modules may be divided based on a read-and-write speed of each data storage module. A level of a data storage module A having a fastest read-and-write speed is a low level, a level of a data storage module B having an intermediate read-and-write speed is an intermediate level, and a level of a data storage module C having a slowest read-and-write speed is a high level.

Accordingly, for each candidate resource combination based on the at least one target resource and the target resource quantity, the multi-level resource pool may be searched in ascending order of levels, to determine the seed resource pools corresponding to the candidate resource combinations. Details may be as follows:

For the candidate code block combination A, based on a quantity of three types of code blocks and a quantity of various types of code blocks in the candidate code block combination A, namely, {[code block A, 1]; [code block C, 3]; and [code block F, 4]}, the low-level data storage module A is searched first to obtain one code block A and two code blocks C, then the intermediate-level data storage module B is searched to obtain one code block C and one code block F, and further the high-level data storage module C is searched to obtain three code blocks F. The ascending order of the levels of the data storage modules is the descending order of the read-and-write speeds of the data storage modules. Therefore, a needed code block is preferentially scheduled from a data storage module having a fast read-and-write speed, which can improve the efficiency of resource scheduling.

The code block A is scheduled from the data storage module A, the code block C is scheduled from the data storage module B, and the code block F is scheduled from the data storage module C. Therefore, the data storage module A, the data storage module B, and the data storage module C are all determined as seed resource pools corresponding to the candidate code block combination A. The seed resource pool is a resource pool used to provide a resource that needs to be scheduled for the candidate resource combination. If there is another data storage module D and the data storage module D does not provide a resource for the candidate code block combination A, the data storage module D cannot be determined as the seed resource pool corresponding to the candidate code block combination A.

Referring to FIG. 4C, in some embodiments, when the target task relates to physical resource scheduling, for example, to satisfy a material requirement, materials are scheduled from storage warehouses at various places. In this type of service scenario, the resource pool is “a storage warehouse stored with materials”, and may specifically include a storage warehouse A, a storage warehouse B, and a storage warehouse C. Levels of the storage warehouses are divided based on a distance between each storage warehouse and a material gap. A level of a storage warehouse A closest to the material gap is a low level, a level of a storage warehouse B intermediate to the material gap is an intermediate level, and a level of a storage warehouse C farthest to the material gap is a high level.

Accordingly, for each candidate resource combination based on the at least one target resource and the target resource quantity, the multi-level resource pool may be searched in ascending order of levels, to determine the seed resource pools corresponding to the candidate resource combinations. Details may be as follows:

For the candidate material combination A, based on a quantity of three types of materials and a quantity of various types of materials in the candidate material combination A, namely, {[material A, 33]; [material C, 45]; and [material F, 48]}, the low-level storage warehouse A is searched first to obtain 15 materials A and 20 materials C, then the intermediate-level storage warehouse B is searched to obtain 18 materials A, 10 materials C, and 20 materials F, and further the high-level storage warehouse C is searched to obtain 15 materials C and 28 materials F. The ascending order of the levels of the storage warehouses is an order of distances between the storage warehouses and the material gaps from near to far. Therefore, a needed material is scheduled from a storage warehouse close to the material gap, which can improve the efficiency of resource scheduling.

The material A is scheduled from the storage warehouse A, the material Cis scheduled from the storage warehouse B, and the material F is scheduled from the storage warehouse C. Therefore, the storage warehouse A, the storage warehouse B, and the storage warehouse C are all determined as seed resource pools corresponding to the candidate material combination A. The seed resource pool is a resource pool used to provide a resource that needs to be scheduled for the candidate resource combination. If there is another storage warehouse D, but the storage warehouse D does not provide a resource for the candidate material combination A, the storage warehouse D cannot be determined as the seed resource pool corresponding to the candidate material combination A.

In operation 330, in the plurality of seed resource pools based on the levels of the seed resource pools corresponding to the candidate resource combinations, the target resource pool used to satisfy the resource scheduling request is determined. After the plurality of seed resource pools are determined, the target resource pool used to satisfy the resource scheduling request is further determined in the plurality of seed resource pools through operation 330. Performing resource scheduling based on any candidate resource combination in the plurality of candidate resource combinations can satisfy the resource scheduling request of the target task. However, satisfying the resource scheduling request has a difference in scheduling effects. Therefore, in the plurality of seed resource pools based on the levels of the seed resource pools corresponding to the candidate resource combinations, the target resource pool used to satisfy the resource scheduling request needs to be determined.

In some embodiments, when the target task relates to virtual resource scheduling, for example, to construct an application, code blocks need to be invoked from different data storage modules. The data storage module is the resource pool. Levels of the data storage modules may be determined based on a read-and-write speed of each data storage module. A level of a data storage module A having a fastest read-and-write speed is a low level, a level of a data storage module B having an intermediate read-and-write speed is an intermediate level, and a level of a data storage module C having a slowest read-and-write speed is a high level. In this type of service scenario, if resource scheduling is performed based on the candidate code block combination A, a code block is obtained from the data storage module A. If resource scheduling is performed based on the candidate code block combination B, code blocks are obtained from the data storage module B and the data storage module C. In view of a case in which the level of the data storage module A is lower than the level of the data storage module B and the level of the data storage module C, and the read-and-write speed of the data storage module A is faster, the data storage module A is determined as the target resource pool used to satisfy the resource scheduling request, so that the efficiency of resource scheduling can be improved.

In some other embodiments, when the target task relates to physical resource scheduling, for example, to satisfy a material requirement, materials are scheduled from storage warehouses at various places. The storage warehouses are resource pools, and levels of the storage warehouses are divided based on a distance between each storage warehouse and the material gap. A level of the storage warehouse A closest to the material gap is a low level, a level of the storage warehouse B intermediate to the material gap is an intermediate level, and a level of the storage warehouse C farthest to the material gap is a high level. In this type of service scenario, if resource scheduling is performed based on the candidate material combination A, a material is obtained from the storage warehouse A. If resource scheduling is performed based on the candidate material combination B, materials are obtained from the storage warehouse B and the storage warehouse C. In view of a case in which the level of the storage warehouse A is lower than the level of the storage warehouse B and the level of the storage warehouse C, and the storage warehouse A is closer to the material gap, the storage warehouse A is determined as the target resource pool used to satisfy the resource scheduling request, so that the efficiency of resource scheduling can be improved.

Referring to an embodiment shown in FIG. 4D, a plurality of candidate resource combinations corresponding to the target task are obtained in response to the resource scheduling request of the target task, which specifically include a candidate resource combination A, a candidate resource combination B, a candidate resource combination C, a candidate resource combination D, a candidate resource combination E, and a candidate resource combination F.

Further, for each candidate resource combination based on the at least one target resource and the target resource quantity, the multi-level resource pool is searched in ascending order of levels, to determine the seed resource pools corresponding to the candidate resource combinations. Levels of a resource pool level A, a resource pool level B, a resource pool level C, and a resource pool level D sequentially increase. Resource pools of the resource pool level A include a resource pool A1, a resource pool A2, a resource pool A3, and the like. Resource pools of the resource pool level B include a resource pool B1, a resource pool B2, a resource pool B3, and the like. Resource pools of the resource pool level C include a resource pool C1, a resource pool C2, a resource pool C3, and the like. Resource pools of the resource pool level D include a resource pool D1, a resource pool D2, a resource pool D3, and the like. A plurality of corresponding seed resource pools may be determined in each candidate resource combination.

A set of a plurality of seed resource pools corresponding to a candidate resource combination may be referred to as a seed resource pool set. Specifically, for each candidate resource combination, the multi-level resource pool is searched in ascending order of levels based on the at least one target resource and the target resource quantity, to determine a seed resource pool set A corresponding to the candidate resource combination A, determine a seed resource pool set B corresponding to the candidate resource combination B, determine a seed resource pool set C corresponding to the candidate resource combination C, determine a seed resource pool set D corresponding to the candidate resource combination D, determine a seed resource pool set E corresponding to the candidate resource combination E, and determine a seed resource pool set F corresponding to the candidate resource combination F.

Further, the target resource pool used to satisfy the resource scheduling request is determined in the plurality of seed resource pools based on the levels of the seed resource pools corresponding to the candidate resource combinations. In the embodiment of the present disclosure shown in FIG. 4D, the seed resource pool corresponding to the candidate resource combination B is determined as the target resource pool. Therefore, the three seed resource pools: the resource pool A1, the resource pool B2, and the resource pool C3 that are specifically included in the seed resource pool set B are also determined as target resource pools used to satisfy the resource scheduling request.

There are various specific implementations of the resource scheduling method in the present disclosure, which are not limited to the specific embodiment listed in FIG. 4D.

In the embodiments of the present disclosure shown in operation 310 to operation 330, in the resource scheduling method, in response to a resource scheduling request of a target task, a plurality of candidate resource combinations corresponding to the target task are obtained, where each candidate resource combination includes at least one target resource needed by the target task and a target resource quantity of the target resource. Then, for each candidate resource combination based on the at least one target resource and the target resource quantity, a multi-level resource pool is searched in ascending order of levels, to determine seed resource pools corresponding to the candidate resource combinations. Therefore, a series of corresponding seed resource pools may be determined in each candidate resource combination corresponding to the target task. Further, a target resource pool used to satisfy the resource scheduling request is determined in the plurality of seed resource pools based on levels of the seed resource pools corresponding to the candidate resource combinations. Because in the resource scheduling method in the present disclosure, the target resource pool satisfying the resource scheduling request is determined based on the levels of the seed resource pools corresponding to the candidate resource combinations, the resource scheduling request of the target task can be responded to quickly. Accordingly, the efficiency of resource scheduling can be improved. The foregoing solution can be applied to various application scenarios, a target resource pool used to satisfy a resource scheduling request is properly determined, and therefore, flexibility of resource scheduling is high.

### Detailed Descriptions of Operation 320

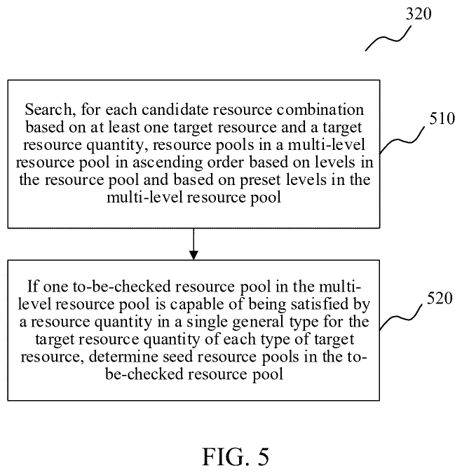

Referring to FIG. 5, in some embodiments provided in the present disclosure, each storage resource pool in the multi-level resource pool includes various storage resources of various general types and resource quantities of the storage resources in the various general types. Operation 320 may include, but is not limited to, the following operation 510 and operation 520.

Operation 510: Search, for each candidate resource combination based on the at least one target resource and the target resource quantity, resource pools in a multi-level resource pool in ascending order based on preset levels in the multi-level resource pool.

Operation 520: If one resource pool to be checked in the multi-level resource pool is capable of being satisfied by a resource quantity in a single general type for the target resource quantity of the target resource, determine the seed resource pools in the resource pool to be checked.

Operation 510 and operation 520 are described in detail below.

In operation 510, for each candidate resource combination based on the at least one target resource and the target resource quantity, the multi-level resource pool is searched in the ascending order of the levels. To determine, from the multi-level resource pool, the seed resource pool providing the candidate resource combination with the resource that needs to be scheduled, the multi-level resource pool needs to be searched for each candidate resource combination, and the multi-level resource pool is searched based on levels of the resource pools, and searching is performed in ascending order of levels. There may be various rating references for levels of the resource pools.

In operation 520, if one resource pool to be checked in the multi-level resource pool is capable of being satisfied by a resource quantity in a single general type for the target resource quantity of the target resource, the seed resource pools are determined in the resource pool to be checked. The resource pool to be checked is a resource pool to be searched in a process of searching the multi-level resource pool to determine the seed resource pool. When the resource pool to be checked can satisfy a target resource quantity of each type of target resource in the candidate resource combination, and each type of target resource can be satisfied by a resource quantity in a single general type, the seed resource pool may be determined in the resource pool to be checked.

A general type refers to a general type of a target resource. Target resources of a same general type may be mixed, and target resources of different general types cannot be mixed. In some cases, a resource stored in a resource pool may not satisfy a requirement of a resource scheduling request for each resource subdivision type, and resources in a same general type may be replaced with each other and play a same function. Therefore, when the resource pool cannot satisfy a requirement of the resource scheduling request for each resource subdivision type, equal replacement of resources in a same general type is performed, which may also satisfy the resource scheduling request. Accordingly, flexibility of resource scheduling can be improved.

In some embodiments, when the target resource is a code block, a general type A includes a code block A1, a code block A2, and a code block A3 that are used to implement a function A. A general type B includes a code block B1, a code block B2, and a code block B3 that are used to implement a function B. The code block A1, the code block A2, and the code block A3 in the general type A may replace each other in effect. When the resource scheduling request needs a code block of the general type A, any one of the code block A1, the code block A2, and the code block A3 may be invoked in the data storage module as the target resource for scheduling. Even if the code block A1 is not stored in the data storage module, as long as the code block A2 or the code block A3 is stored in the data storage module, the resource scheduling request can be satisfied. The code block B1, the code block B2, and the code block B3 in the general type B cannot satisfy a requirement of the resource scheduling request for the code block of the general type A.

In some other embodiments, when the target resource is a cable, the general type A includes three types of cables: a cable of a model A1, a cable of a model A2, and a cable of a model A3. The general type B includes three types of cables: a cable of a model B1, a cable of a model B2, and a cable of a model B3. The cable of the model A1, the cable of the model A2, and the cable of the model A3 in the general type A may be mixed. When the cable of the model A1 has insufficient storage and cannot satisfy the resource scheduling request, the cable of the model A2 or the cable of the model A3 may be used for supplement, to satisfy the resource scheduling request. The three types of cables in the general type B: the cable of the model B1, the cable of the model B2, and the cable of the model B3 cannot be used for supplement of the insufficient storage of the cable of the model A1.

If one resource pool to be checked is capable of being satisfied by a resource quantity in a single general type for a target resource quantity of each type of target resource, it means that the resource pool to be checked can satisfy the resource scheduling request at one time. In the embodiments of the present disclosure, to improve the efficiency of resource scheduling, a resource pool that satisfies the resource scheduling request at one time may be determined as the seed resource pool. In some embodiments, a plurality of resource pool to be checked that can satisfy the resource scheduling request at one time may also exist in the multi-level resource pool. In this case, the seed resource pool needs to be determined in the plurality of resource pools to be checked.

In the embodiments of the present disclosure shown in operation 510 and operation 520, if one resource pool to be checked in the multi-level resource pool is capable of being satisfied by the resource quantity in the single general type for the target resource quantity of each type of target resource, the resource pool to be checked can satisfy the resource scheduling request at one time. Because the resource pool to be checked can satisfy the resource scheduling request at one time, the resource pool to be checked is determined as the seed resource pool, which helps further improve the efficiency of resource scheduling.

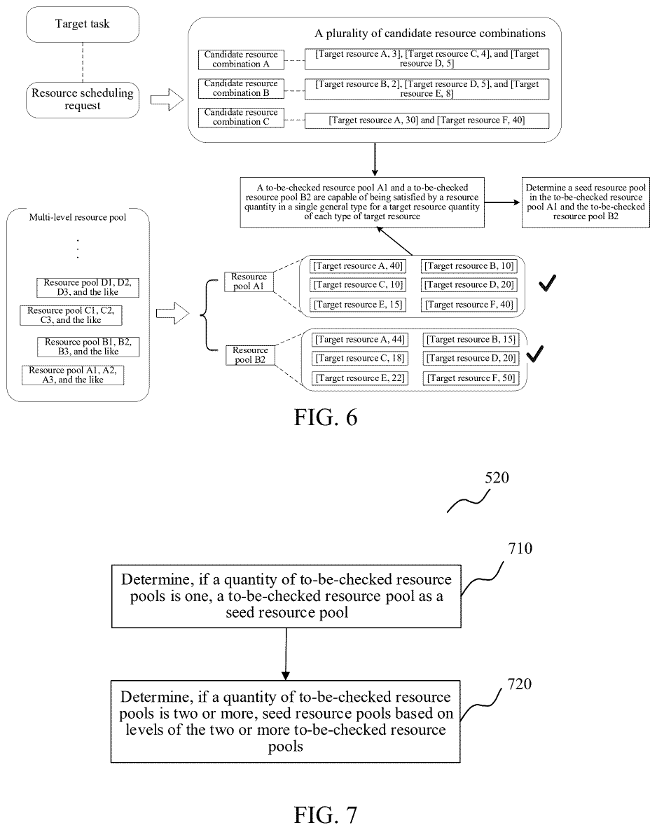

Referring to some embodiments of the present disclosure provided in FIG. 6, a case in which one resource pool to be checked in the multi-level resource pool is capable of being satisfied by the resource quantity in the single general type for the target resource quantity of each type of target resource is shown. Specifically, the resource scheduling request includes a candidate resource combination A, a candidate resource combination B, and a candidate resource combination C. Each candidate resource combination has a corresponding plurality of types of target resources and a target resource quantity that needs to be satisfied. The candidate resource combination A needs three target resources A, four target resources C, and five target resources D, the candidate resource combination B needs two target resources B, five target resources D, and eight target resources E, and the candidate resource combination C needs 30 target resources A and 40 target resources F.

It may be clarified that, a target resource quantity of each type of target resource in the target resources A, the target resources B, the target resources C, the target resources D, the target resources E, and the target resources F can be satisfied by the resource quantity in the single general type. This means that at least 33 resources that are in a same general type as the target resources A are stored in the resource pool to be checked, at least two resources that are in a same general type as the target resources B are stored in the resource pool to be checked, at least four resources that are in a same general type as the target resources C are stored in the resource pool to be checked, at least ten resources that are in a same general type as the target resources D are stored in the resource pool to be checked, at least eight resources that are in a same general type as the target resources E are stored in the resource pool to be checked, and at least 40 resources that are in a same general type as the target resources F are stored in the resource pool to be checked.

Based on this, based on various types of target resources and the target resource quantity, the multi-level resource pool is searched in ascending order of levels, and it may be determined that, the multi-level resource pool includes a resource pool to be checked A1 and a resource pool to be checked B2. A target resource quantity of each type of target resource in the target resources A, the target resources B, the target resources C, the target resources D, the target resources E, and the target resources F can be satisfied by the resource quantity in the single general type. Therefore, the seed resource pool can be determined in the resource pool to be checked A1 and the resource pool to be checked B2.

Referring to FIG. 7, in some embodiments provided in the present disclosure, operation 520 may include, but is not limited to, the following operation 710 and operation 720.

Operation 710: Determine, if a quantity of resource pools to be checked is one, the resource pool to be checked as the seed resource pool.

Operation 720: Determine, if a quantity of resource pools to be checked is two or more, the seed resource pools based on levels of the two or more resource pools to be checked.

Operation 710 and operation 720 are described in detail below.

In operation 710, if the quantity of resource pools to be checked is one, the resource pool to be checked is determined as the seed resource pool. The resource pool to be checked is a resource pool to be searched in a process of searching the multi-level resource pool to determine the seed resource pool. If there is only one resource pool to be checked in the multi-level resource pool, it means that there is only one resource pool in the multi-level resource pool that can be used to satisfy the resource scheduling request. Therefore, the resource pool to be checked may be determined as the seed resource pool.

In operation 720, if the quantity of resource pools to be checked is two or more, the seed resource pools are determined based on levels of the two or more resource pools to be checked. If the quantity of resource pools to be checked is two or more in the multi-level resource pool, it means that two or more resource pools in the multi-level resource pool can be used to satisfy the resource scheduling request, and the seed resource pools need to be determined based on levels of the two or more resource pools to be checked.

According to the embodiments of the present disclosure shown in operation 710 and operation 720, when only one resource pool to be checked in the multi-level resource pool can satisfy the resource scheduling request, the resource pool to be checked is determined as the seed resource pool, so that economic costs and time costs that are generated in a resource scheduling process can be reduced, and the efficiency of resource scheduling can be improved. However, when there are two or more resource pools to be checked in the multi-level resource pool that can satisfy the resource scheduling request, preferred selection needs to be performed on the two or more resource pools to be checked based on levels of the resource pools, to further reduce the economic costs and the time costs that are generated in the resource scheduling process, and improve the efficiency of resource scheduling.

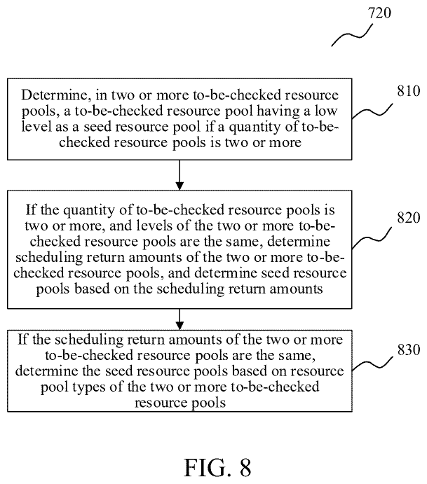

Referring to FIG. 8, in some embodiments provided in the present disclosure, operation 720 may include, but is not limited to, the following operation 810 to operation 830.

Operation 810: Determine, in the two or more resource pools to be checked, a resource pool to be checked having a low level as the seed resource pool if a quantity of resource pools to be checked is two or more.

Operation 820: If the quantity of resource pools to be checked is two or more, and levels of the two or more resource pools to be checked are the same, determine scheduling return amounts of the two or more resource pools to be checked, and determine the seed resource pools based on the scheduling return amounts.

Operation 830: If the scheduling return amounts of the two or more resource pools to be checked are the same, determine the seed resource pools based on resource pool types of the two or more resource pools to be checked.

Operation 810 to operation 830 are described in detail below.

In operation 810, in the two or more resource pools to be checked, the resource pool to be checked having the low level is determined as the seed resource pool if the quantity of resource pools to be checked is two or more. The resource pool to be checked is a resource pool to be searched in a process of searching the multi-level resource pool to determine the seed resource pool. If the quantity of resource pools to be checked is two or more, and there is a difference between levels corresponding to the two or more resource pools to be checked, preferred selection may be performed on the two or more resource pools to be checked based on the levels of the resource pools to be checked, to further reduce the economic costs and the time costs that are generated in the resource scheduling process, and improve the efficiency of resource scheduling.

In operation 820, if the quantity of resource pools to be checked is two or more, and the levels of the two or more resource pools to be checked are the same, the scheduling return amounts of the two or more resource pools to be checked are determined, and the seed resource pools are determined based on the scheduling return amounts. If the quantity of resource pools to be checked is two or more, and the levels corresponding to the two or more resource pools to be checked are the same, the scheduling return amounts of the two or more resource pools to be checked need to be determined, to perform preferred selection based on the scheduling return amounts. The scheduling return amount is a balance amount of a resource pool that needs to be returned in a process of performing resource scheduling by using a storage amount of the resource pool. The scheduling return amount is generated because the storage amount of the resource pool fails to exactly satisfy the resource scheduling request. Therefore, a smaller scheduling return amount of the resource pool to be checked means lower overheads of returning a balance resource to the resource pool. It can be clarified that, when the levels of the two or more resource pools to be checked are the same, the scheduling return amounts of the two or more resource pools to be checked are determined, and the seed resource pools are determined based on the scheduling return amounts, to reduce the economic costs and the time costs that are generated in the resource scheduling process, and improve the efficiency of resource scheduling.

In operation 830, if the scheduling return amounts of the two or more resource pools to be checked are the same, the seed resource pools are determined based on the resource pool types of the two or more resource pools to be checked. If the quantity of resource pools to be checked is two or more, the levels corresponding to the two or more resource pools to be checked are the same, and the scheduling return amounts of the two or more resource pools to be checked are also the same, the seed resource pools are determined based on the resource pool types of the two or more resource pools to be checked. The resource pool types may include a plurality of classification standards, for example, a resource pool type obtained by performing classification based on a capacity scale, a resource pool type obtained by performing classification based on a remaining storage amount, a resource pool type obtained by performing classification based on a resource scheduling permission, and various other resource pool types.

According to this embodiment of the present disclosure shown in operation 810 to operation 830, to determine the seed resource pool from the two or more resource pools to be checked, preferred selection needs to be first performed on the two or more resource pools to be checked based on the levels of the resource pool, and a resource pool to be checked having a low is determined as the seed resource pool. If the corresponding levels of the two or more resource pools to be checked are the same, preferred selection is then performed on the two or more resource pools to be checked based on the scheduling return amounts. If the corresponding levels of the two or more resource pools to be checked are the same, and the scheduling return amounts are also the same, preferred selection is performed based on the resource pool types of the two or more resource pools to be checked, to finally determine the seed resource pool. Accordingly, the seed resource pool may be selected from the two or more resource pools to be checked, to further reduce the costs of resource scheduling, and improve the efficiency of resource scheduling.

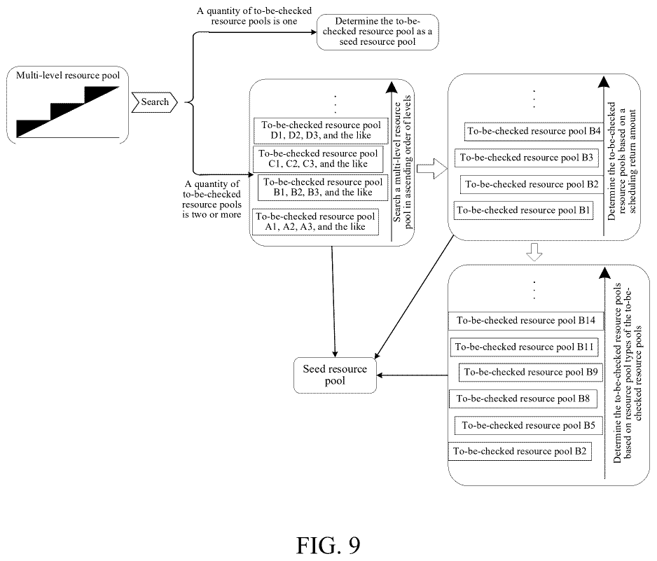

Referring to FIG. 9, in some embodiments, the multi-level resource pool needs to be searched. If the quantity of resource pools to be checked is one, the resource pool to be checked is determined as the seed resource pool. If the quantity of resource pools to be checked is two or more, specifically, levels of a resource pool level A, a resource pool level B, a resource pool level C, and a resource pool level D sequentially increase. Resource pools of the resource pool level A include a resource pool A1, a resource pool A2, a resource pool A3, and the like. Resource pools of the resource pool level B include a resource pool B1, a resource pool B2, a resource pool B3, and the like. Resource pools of the resource pool level C include a resource pool C1, a resource pool C2, a resource pool C3, and the like. Resource pools of the resource pool level D include a resource pool D1, a resource pool D2, a resource pool D3, and the like.

In the embodiments of the present disclosure, if the quantity of resource pools to be checked is two or more, preferred selection needs to be performed on the two or more resource pools to be checked based on the levels of the resource pools, and the resource pool to be checked having the low level is determined as the seed resource pool from a resource pool level A, a resource pool level B, a resource pool level C, and a resource pool level D.

If only a plurality of resource pools to be checked such as the resource pool B1, the resource pool B2, the resource pool B3, and the resource pool B4 that correspond to the resource pool level B can satisfy the resource scheduling request, the levels corresponding to the two or more resource pools to be checked are the same, and preferred selection further needs to be performed on the two or more resource pools to be checked based on the scheduling return amounts, to determine the seed resource pool.

If a plurality of resource pools to be checked such as the resource pool B2, the resource pool B5, the resource pool B8, the resource pool B9, the resource pool B11, and the resource pool B14 can satisfy the resource scheduling request and have the same scheduling return amounts, the seed resource pool needs to be determined based on resource pool types corresponding to the plurality of resource pools to be checked such as the resource pool B2, the resource pool B5, the resource pool B8, the resource pool B9, the resource pool B11, and the resource pool B14.

Accordingly, the seed resource pool may be selected from the two or more resource pools to be checked, to further reduce the costs of resource scheduling, and improve the efficiency of resource scheduling.

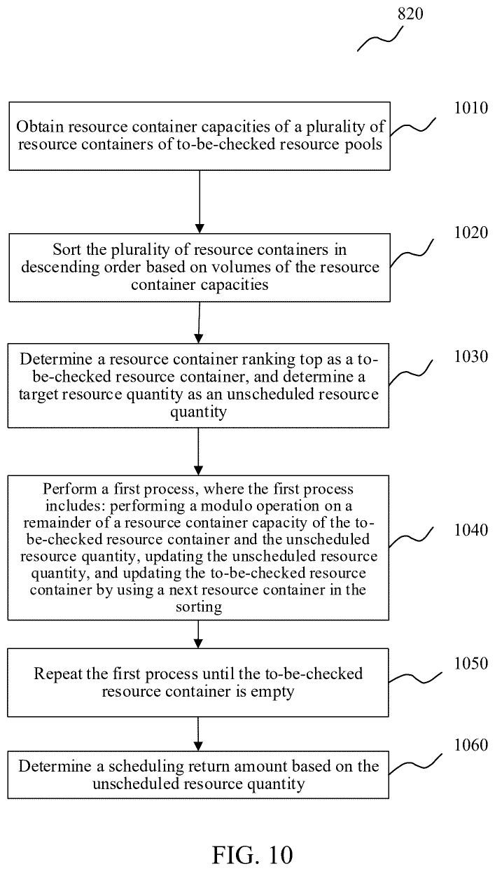

Referring to FIG. 10, in some embodiments provided in the present disclosure, in operation 820, the determining scheduling return amounts of the two or more resource pools to be checked may include, but is not limited to, the following operation 1010 to operation 1060.

Operation 1010: Obtain resource container capacities of a plurality of resource containers of the resource pools to be checked;
operation 1020: Sort the plurality of resource containers in descending order based on volumes of the resource container capacities;
operation 1030: Determine a resource container ranking top as a to-be-checked resource container, and determine the target resource quantity as an unscheduled resource quantity;
operation 1040: Perform a first process, where the first process includes: performing a modulo operation on a remainder of a resource container capacity of the to-be-checked resource container and the unscheduled resource quantity, updating the unscheduled resource quantity, updating the to-be-checked resource container by using a next resource container in the sorting;
operation 1050: Repeat the first process until the to-be-checked resource container is empty; and
operation 1060: Determine the scheduling return amount based on the unscheduled resource quantity.

Operation 1010 to operation 1060 are described in detail below.

In operation 1010, the resource container capacities of the plurality of resource containers of the resource pools to be checked are obtained. Each resource in the resource pool to be checked may be specifically stored through the resource container, and each resource container can store a specific quantity of resources. The resource container capacity is a quantity of resources that can be stored by the resource container. Because quantities of resources that can be stored by different resource containers are different, resource container capacities of different resource containers may also be different.

In operation 1020, the plurality of resource containers are sorted in the descending order based on the volumes of the resource container capacities. The plurality of resource containers are sorted in the descending order based on the volumes of the resource container capacities, to perform resource scheduling based on this sorting in subsequent operations, and determine a scheduling return amount corresponding to the resource pool to be checked. A resource container ranking top is a resource container having a largest resource container capacity.

In operation 1030 to operation 1050, the resource container ranking top is determined as the to-be-checked resource container, and the target resource quantity is determined as the unscheduled resource quantity. Further, the first process is performed, where the first process includes: performing a modulo operation on the remainder of the resource container capacity of the to-be-checked resource container and the unscheduled resource quantity, updating the unscheduled resource quantity, updating the to-be-checked resource container by using the next resource container in the sorting, and repeating the first process until the to-be-checked resource container is empty. The plurality of resource containers are sorted in the descending order based on the volumes of the resource container capacities, where the resource container ranking top is the resource container having the largest resource container capacity. Based on this, to satisfy a resource scheduling request, the resource container ranking top needs to be first determined as the to-be-checked resource container, the target resource quantity needs to be determined as the unscheduled resource quantity, and then the first process is performed based on the to-be-checked resource container and the unscheduled resource quantity, to update the to-be-checked resource container and the unscheduled resource quantity. In the first process, a modulo operation needs to be first performed on the remainder of the resource container capacity of the to-be-checked resource container and the unscheduled resource quantity. Because the unscheduled resource quantity is usually greater than a resource container capacity of a single to-be-checked resource container, the resource container capacity of the to-be-checked resource container generally can only satisfy a part of the unscheduled resource quantity, and cannot satisfy the unscheduled resource quantity at one time. Therefore, a modulo operation needs to be performed on the unscheduled resource quantity and the resource container capacity of the to-be-checked resource container, to obtain a remainder corresponding to the unscheduled resource quantity that cannot be satisfied by the current to-be-checked resource container. Because the resource container capacity of the to-be-checked resource container satisfies a part of the unscheduled resource quantity, further the unscheduled resource quantity is updated, then to determine an updated unscheduled resource quantity that can be satisfied by a resource container capacity of a next resource container, the to-be-checked resource container needs to be updated by using the next resource container in the sorting, and the first process is repeated until the to-be-checked resource container is empty. In the first process in each round, the to-be-checked resource container needs to be updated by using the next resource container in the sorting, which is equivalent to a process of replacing the current resource container with the next resource container as the updated to-be-checked resource container. When the to-be-checked resource container is empty, that is, there is no next resource container, it means that traversing of the resource containers in the sorting is completed.

In operation 1060, the scheduling return amount is determined based on the unscheduled resource quantity. Operation 1030 to operation 1050 are performed until the to-be-checked resource container is empty, the resource containers in the sorting may be traversed as many as possible. In this case, the unscheduled resource quantity becomes a resource quantity that cannot be exactly satisfied by the resource containers in the sorting. Therefore, a scheduling return amount of a resource pool that needs to be returned in a resource scheduling process may be determined based on comparison between the unscheduled resource quantity and a resource container having a smallest resource container capacity in the sorting.

In the embodiments of the present disclosure shown in operation 1010 to operation 1050, a series of feasible operations of determining the scheduling return amount of the resource pool to be checked are shown. In each operation, a large resource container capacity is used to satisfy the target resource quantity, and then a large resource container capacity is used to satisfy a remaining target resource quantity, until the resource container having the smallest resource container capacity cannot completely satisfy the target resource quantity, so that the scheduling return amount of the resource pool that needs to be returned can be determined. Accordingly, the seed resource pool may be conveniently selected from the two or more resource pools to be checked, to further reduce the costs of resource scheduling, and improve the efficiency of resource scheduling.

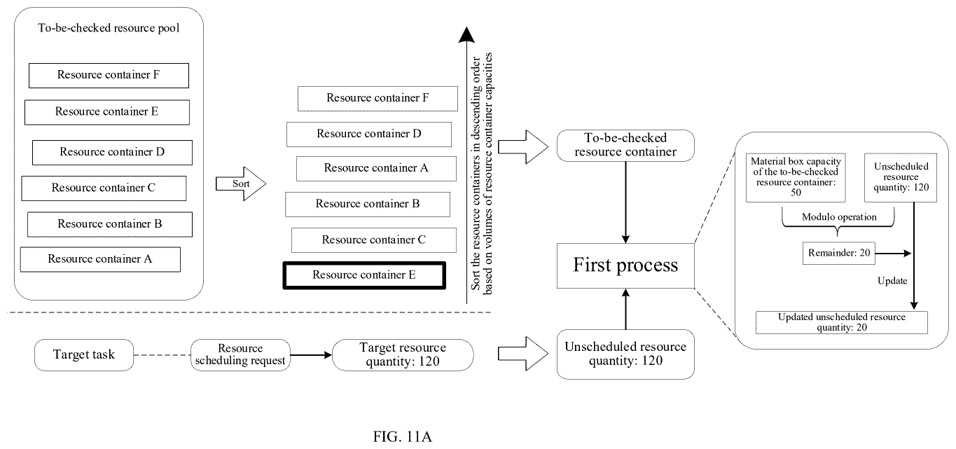

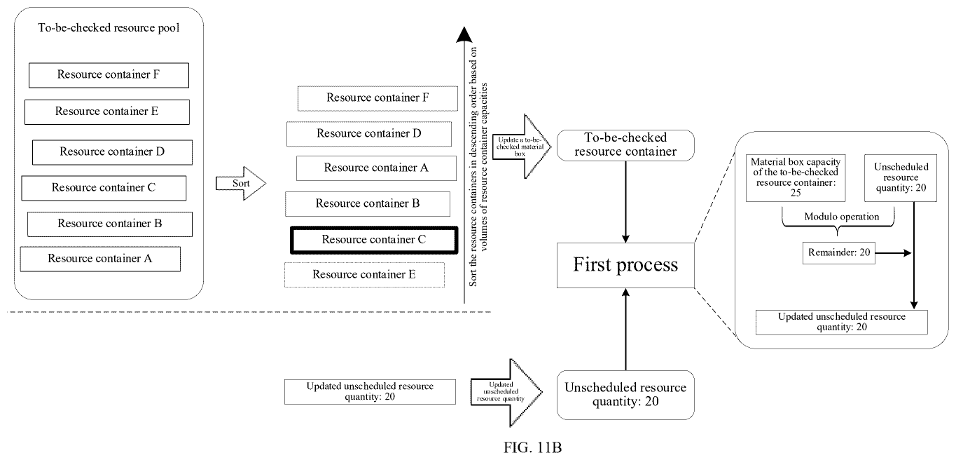

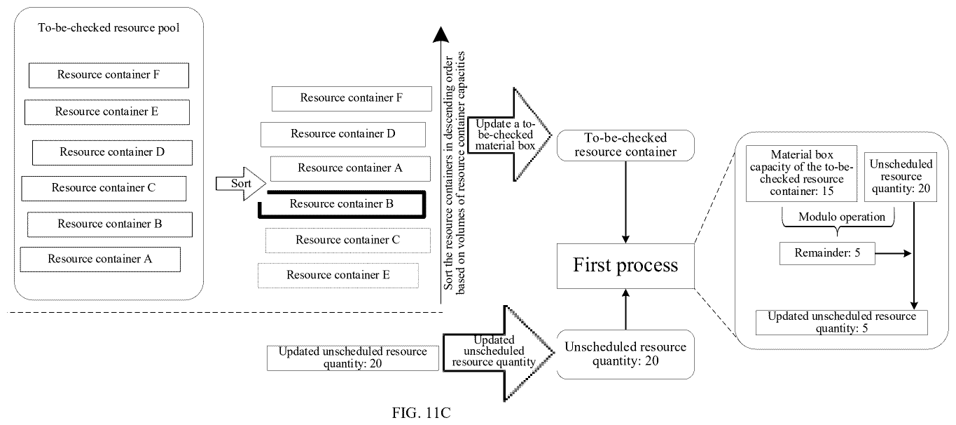

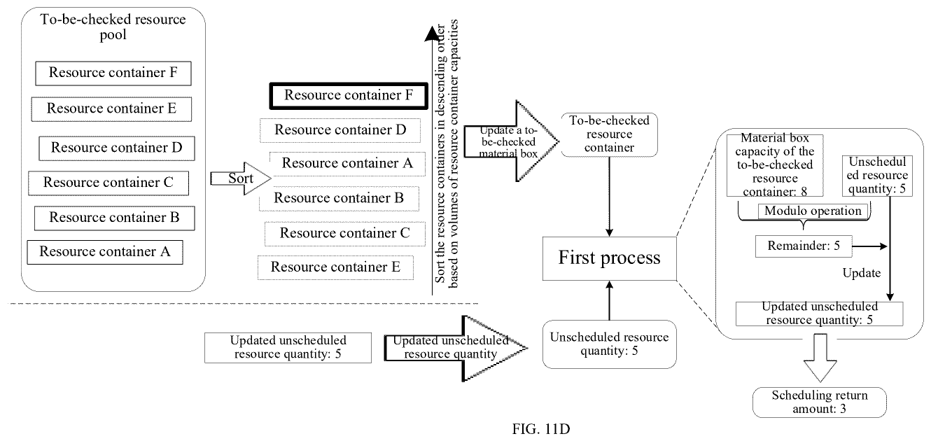

Referring to some embodiments of the present disclosure shown in FIG. 11A to FIG. 11D, an example process of determining the scheduling return amount of the resource pool to be checked is shown.

In FIG. 11A, the resource pool to be checked includes a resource container A, a resource container B, a resource container C, a resource container D, a resource container E, and a resource container F. A plurality of resource containers are sorted in descending order of capacities of the resource containers, to obtain a resource container E, a resource container C, a resource container B, a resource container A, a resource container D, and a resource container F that are sequentially sorted. Further, the resource container E ranking top is determined as the to-be-checked resource container, the target resource quantity 120 is determined as the unscheduled resource quantity, and the first process starts to be performed. In the first process in the first round, the resource container capacity of the to-be-checked resource container needs to be determined first, namely, a resource container capacity 50 in the resource container E, and a modulo operation: 120% 50 is performed on the resource container capacity 50 of the to-be-checked resource container and the unscheduled resource quantity 120, to obtain a remainder 20.

After the remainder 20 is obtained, the unscheduled resource quantity is updated to 20, and the to-be-checked resource container is updated by using the next resource container C in the sorting.

In FIG. 11B, the to-be-checked resource container is the resource container C, and the unscheduled resource quantity is 20. Based on this, a new round of first process is performed. The resource container capacity 25 in the resource container C is first determined, and a modulo operation: 20% 25 is performed on the resource container capacity 25 of the to-be-checked resource container and the unscheduled resource quantity 20, to obtain a remainder 20. The resource container capacity 25 in the resource container C is greater than the unscheduled resource quantity 20. Therefore, the unscheduled resource quantity is not changed in this round of first process.

After the remainder 20 is obtained, the unscheduled resource quantity is updated to 20, and the to-be-checked resource container is updated by using the next resource container B in the sorting.

In FIG. 11C, the to-be-checked resource container is the resource container B, and the unscheduled resource quantity is 20. Based on this, a new round of first process is performed. The resource container capacity 15 in the resource container B is first determined, and a modulo operation: 20% 15 is performed on the resource container capacity 15 of the to-be-checked resource container and the unscheduled resource quantity 20, to obtain a remainder 5. The resource container capacity 15 in the resource container C is less than the unscheduled resource quantity 20. Therefore, the unscheduled resource quantity 20 is adjusted as the unscheduled resource quantity 5 in this round of first process.

After the unscheduled resource quantity is updated to 5, the to-be-checked resource container is updated by using the next resource container A in the sorting. The first process is repeated in the foregoing manner.

In FIG. 11D, until the first process corresponding to the resource container F ends, the to-be-checked resource container is updated to be empty. The resource container capacity 12 in the resource container A, the resource container capacity 10 in the resource container D, and the resource container capacity 8 in the resource container F are all greater than the unscheduled resource quantity 5. Therefore, the unscheduled resource quantity 5 is not changed in the first process in the three rounds. It may be clarified that, the corresponding unscheduled resource quantity is 5 after the first process ends. In this case, further, a scheduling return amount of a resource pool that needs to be returned in a resource scheduling process may be determined based on comparison between the unscheduled resource quantity and a resource container having a smallest resource container capacity in the sorting. Specifically, based on a case in which the unscheduled resource quantity is 5, a resource container that has a smallest resource container capacity of 8 in the sorting is the resource container F. To enable the target resource quantity to be satisfied, the resource container F having the resource container capacity of 8 needs to be used to satisfy the remaining unscheduled resource quantity 5. In this case, a corresponding scheduling return amount of the resource pool that needs to be returned is: 8−5=3. Therefore, in this embodiment of the present disclosure, the scheduling return amount is 3.

Various implementations of determining the scheduling return amount in the resource pool to be checked may include, but are not limited to the foregoing listed specific embodiments.

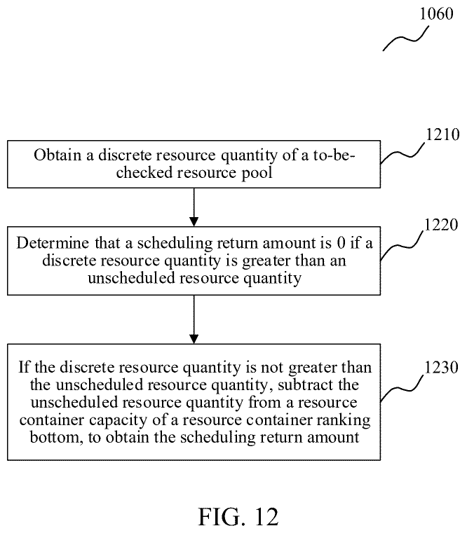

Referring to FIG. 12, in some embodiments provided in the present disclosure, operation 1060 may include, but is not limited to, the following operation 1210 to operation 1230.

Operation 1210: Obtain a discrete resource quantity of the resource pool to be checked;
operation 1220: Determine that the scheduling return amount is 0 if the discrete resource quantity is greater than the unscheduled resource quantity; and
operation 1230: If the discrete resource quantity is not greater than the unscheduled resource quantity, subtract the unscheduled resource quantity from a resource container capacity of a resource container ranking bottom, to obtain the scheduling return amount.

Operation 1210 to operation 1230 are described in detail below.

In operation 1210, the discrete resource quantity of the resource pool to be checked is obtained. The discrete resource quantity refers to a quantity of discrete resources stored in the resource pool to be checked. It may be clarified that, the resource containers sorted in ascending order of volumes of the resource container capacities may not exactly satisfy the target resource quantity. Specifically, after the resource containers in the sorting are traversed as many as possible, the target resource quantity is still not satisfied. If the target resource quantity is satisfied by using the resource container that has the smallest resource container capacity in the sorting, a quantity of resources supplemented with resources of the target resource quantity exceeds the unscheduled resource quantity, to generate the scheduling return amount of the resource pool that needs to be returned. The discrete resources stored in the resource pool to be checked are used to handle this case. When the target resource quantity is still not satisfied after the resource containers in the sorting are traversed as many as possible, the discrete resources are determined from the resource pool to be checked based on the unscheduled resource quantity, to exactly satisfy the target resource quantity.

In operation 1220, it is determined that the scheduling return amount is 0 if the discrete resource quantity is greater than the unscheduled resource quantity. If the discrete resource quantity is greater than the unscheduled resource quantity, it means that resources of the unscheduled resource quantity may be selected from the plurality of discrete resources stored in the resource pool to be checked, to satisfy the target resource quantity, and the target resource quantity is exactly satisfied, so that it may be determined that the scheduling return amount is 0.

In operation 1230, if the discrete resource quantity is not greater than the unscheduled resource quantity, the unscheduled resource quantity is subtracted from the resource container capacity of the resource container ranking bottom, to obtain the scheduling return amount. If the discrete resource quantity is not greater than the unscheduled resource quantity, it means that even if the plurality of discrete resources stored in the resource pool to be checked are supplemented with resources of the target resource quantity, the target resource quantity cannot be satisfied. In this case, a resource container ranking bottom, namely, the resource container that has the smallest resource container capacity in the sorting, needs to be used to satisfy the target resource quantity based on the resource container capacity of the resource container. A quantity of the resources supplemented with the resources of the target resource quantity is to exceed the unscheduled resource quantity. Therefore, the unscheduled resource quantity is subtracted from the resource container capacity of the resource container ranking bottom, to obtain the scheduling return amount, so that preferred selection is performed on the two or more resource pools to be checked based on the scheduling return amount. Because a smaller scheduling return amount indicates fewer overheads of returning the resource to the resource pool, in the two or more resource pools to be checked, a resource pool to be checked having a smaller scheduling return amount may be determined as a better selection.

In the embodiments of the present disclosure shown in operation 1210 to operation 1230, to reduce the overheads of returning the resource to the resource pool, whether the discrete resource quantity in the resource pool to be checked can cover the unscheduled resource quantity needs to be preferentially determined. If the discrete resource quantity can cover the unscheduled resource quantity, discrete resources of the unscheduled resource quantity are determined in the resource pool to be checked, to exactly satisfy the target resource quantity. If the discrete resource quantity is insufficient to cover the unscheduled resource quantity, the resource container having the smallest resource container capacity in the sorting needs to be used to satisfy the target resource quantity. In this case, because the resource supplemented with the resource of the target resource quantity is to exceed the unscheduled resource quantity, the scheduling return amount may be obtained by subtracting the unscheduled resource quantity from the resource container capacity of the resource container ranking bottom. Accordingly, when the levels of the two or more resource pools to be checked are the same, preferred selection may be performed on the two or more resource pools to be checked based on the scheduling return amount, so that the seed resource pool may be selected from the two or more resource pools to be checked, to further reduce the costs of resource scheduling, and improve the efficiency of resource scheduling.

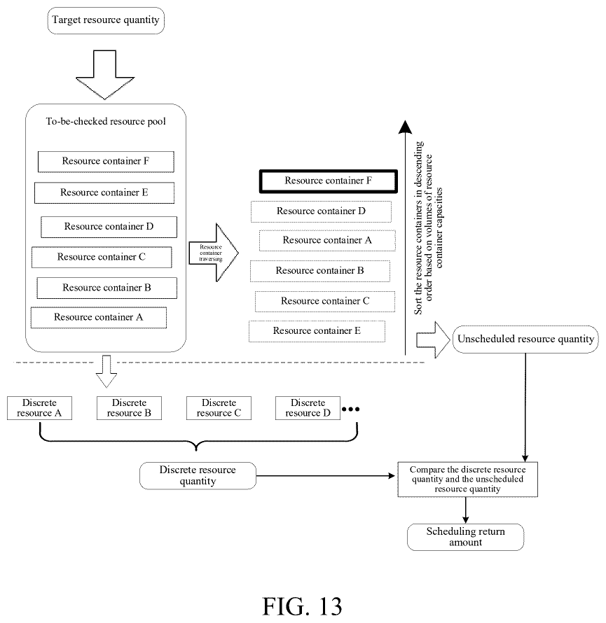

Referring to some embodiments of the present disclosure provided in FIG. 13; FIG. 13 is a diagram of determining a scheduling return amount. When the resource pool to be checked includes six resource containers: a resource container A, a resource container B, a resource container C, a resource container D, a resource container E, and a resource container F, and a plurality of discrete resources such as a discrete resource A, a discrete resource B, a discrete resource C, and a discrete resource D. The resource container A, the resource container B, the resource container C, the resource container D, the resource container E, and the resource container F in the resource pool to be checked are traversed based on the target resource quantity, and each resource container cannot exactly satisfy the target resource quantity. Therefore, the unscheduled resource quantity may be obtained. To further determine the scheduling return amount corresponding to the resource pool to be checked, the discrete resource quantity of the resource pool to be checked needs to be first obtained, and then the discrete resource quantity is compared with the unscheduled resource quantity. If the discrete resource quantity is greater than the unscheduled resource quantity, it is determined that the scheduling return amount is 0, and if the discrete resource quantity is not greater than the unscheduled resource quantity, the scheduling return amount may be obtained by subtracting the unscheduled resource quantity from the resource container capacity of the resource container ranking bottom. Accordingly, when the levels of the two or more resource pools to be checked are the same, preferred selection may be performed on the two or more resource pools to be checked based on the scheduling return amount, so that the seed resource pool may be selected from the two or more resource pools to be checked, to further reduce the costs of resource scheduling, and improve the efficiency of resource scheduling.

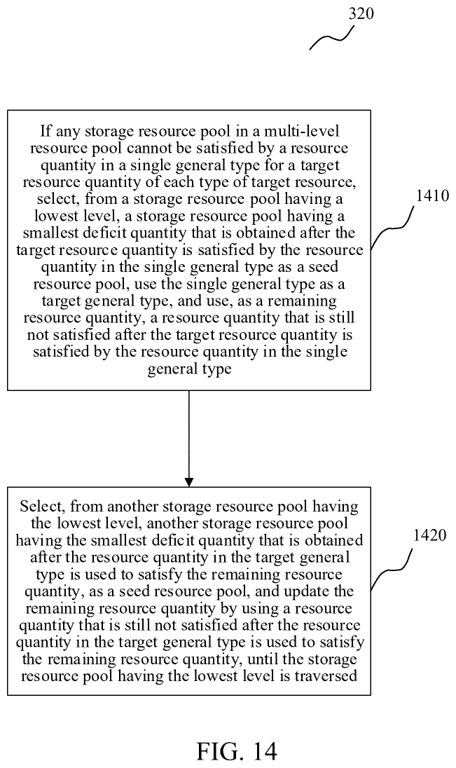

Referring to FIG. 14, in some embodiments provided in the present disclosure, operation 320 may further include, but is not limited to, the following operation 1410 and operation 1420.

Operation 1410: If any storage resource pool in the multi-level resource pool cannot be satisfied by the resource quantity in the single general type for the target resource quantity of each type of target resource, select, from a storage resource pool having a lowest level, a storage resource pool having a smallest deficit quantity that is obtained after the target resource quantity is satisfied by the resource quantity in the single general type as a seed resource pool, use the single general type as a target general type, and use, as a remaining resource quantity, a resource quantity that is still not satisfied after the target resource quantity is satisfied by the resource quantity in the single general type.

Operation 1420: Select, from another storage resource pool having the lowest level, another storage resource pool having the smallest deficit quantity that is obtained after the resource quantity in the target general type is used to satisfy the remaining resource quantity, as a seed resource pool, and update the remaining resource quantity by using a resource quantity that is still not satisfied after the resource quantity in the target general type is used to satisfy the remaining resource quantity, until the storage resource pool having the lowest level is traversed.

Operation 1410 and operation 1420 are described in detail below.

In operation 1410, if any storage resource pool in the multi-level resource pool cannot be satisfied by the resource quantity in the single general type for the target resource quantity of each type of target resource, from the storage resource pool having the lowest level, the storage resource pool having the smallest deficit quantity that is obtained after the target resource quantity is satisfied by the resource quantity in the single general type is selected as the seed resource pool, the single general type is used as the target general type, and the resource quantity that is still not satisfied after the target resource quantity is satisfied by the resource quantity in the single general type is used as the remaining resource quantity. There may be various rating references for levels of the resource pools, the levels of the resource pools increase in ascending order, and overheads caused by resource scheduling of the resource pools sequentially increase.

A general type refers to a general type of a target resource. Target resources of a same general type may be mixed, and target resources of different general types cannot be mixed. In some cases, a resource stored in a resource pool may not satisfy a requirement of a resource scheduling request for each resource subdivision type, and resources in a same general type may be replaced with each other and play a same function. Therefore, when the resource pool cannot satisfy a requirement of the resource scheduling request for each resource subdivision type, equal replacement of resources in a same general type is performed, which may also satisfy the resource scheduling request. Accordingly, flexibility of resource scheduling can be improved.

Therefore, in the embodiments of the present disclosure, if one resource pool to be checked in the multi-level resource pool is capable of being satisfied by the resource quantity in the single general type for the target resource quantity of the target resource, the seed resource pools are determined in the resource pool to be checked. However, if any storage resource pool in the multi-level resource pool cannot be satisfied by the resource quantity in the single general type for the target resource quantity of each type of target resource, the seed resource pool needs to be determined in another manner.

In some embodiments, a storage resource pool having a smallest deficit quantity that is obtained after the resource quantity in the single general type is used to satisfy the target resource quantity may be selected from the storage resource pool having the lowest level as a seed resource pool. An objective is to first satisfy the resource quantity in the single general type as much as possible by using the storage resource pool having the lowest level, determine a deficit quantity of a corresponding resource, and then determine the storage resource pool having the smallest deficit quantity as the seed resource pool. Because the resource pools are sorted in ascending order of levels, overheads caused by resource scheduling of the resource pools sequentially increase. Determining the seed resource pool in this manner helps reduce the overall overheads of resource scheduling and improve the efficiency of resource scheduling.

Further, the single general type is used as the target general type, and the resource quantity that is still not satisfied after the resource quantity in the single general type is used to satisfy the target resource quantity is used as the remaining resource quantity, so that scheduling of the remaining resources is performed in subsequent operations, to supplement the target resource quantity.

In operation 1420, the another storage resource pool having the smallest deficit quantity that is obtained after the resource quantity in the target general type is used to satisfy the remaining resource quantity is selected from the another storage resource pool having the lowest level as a seed resource pool, and the remaining resource quantity is updated by using the resource quantity that is still not satisfied after the resource quantity in the target general type is used to satisfy the remaining resource quantity, until the storage resource pool having the lowest level is traversed.

After the single general type is used as the target general type, and the resource quantity that is still not satisfied after the resource quantity in the single general type is used to satisfy the target resource quantity is used as the remaining resource quantity, to further supplement the target resource quantity, the another storage resource pool having the smallest deficit quantity that is obtained after the resource quantity in the target general type is used to satisfy the remaining resource quantity needs to be determined from the another storage resource pool having the lowest level. A reason lies in that determining the another storage resource pool from the another storage resource pool having the lowest level helps reduce the overall overheads of resource scheduling and improve the efficiency of resource scheduling, and further improves efficiency of supplementing the target resource quantity, and the another storage resource pool having the smallest deficit quantity that is obtained after the resource quantity in the target general type is used to satisfy the remaining resource quantity needs to be selected as the seed resource pool. If the two storage resource pools still cannot supplement the target resource quantity, the resource quantity that is still not satisfied after the resource quantity in the target general type is used to satisfy the remaining resource quantity needs to be used to update the remaining resource quantity, and the another storage resource pool having the lowest level is searched for a next seed resource pool used to provide the target resource, until the storage resource pool having the lowest level is traversed.

In the embodiments of the present disclosure shown in operation 1410 and operation 1420, because the resource pools are sorted in ascending order of levels, overheads caused by resource scheduling of the resource pools sequentially increase. Preferentially determining the seed resource pool in a plurality of storage resource pools having the lowest level helps reduce the overall overheads of resource scheduling and improve the efficiency of resource scheduling, and further improves the efficiency of supplementing the target resource quantity.

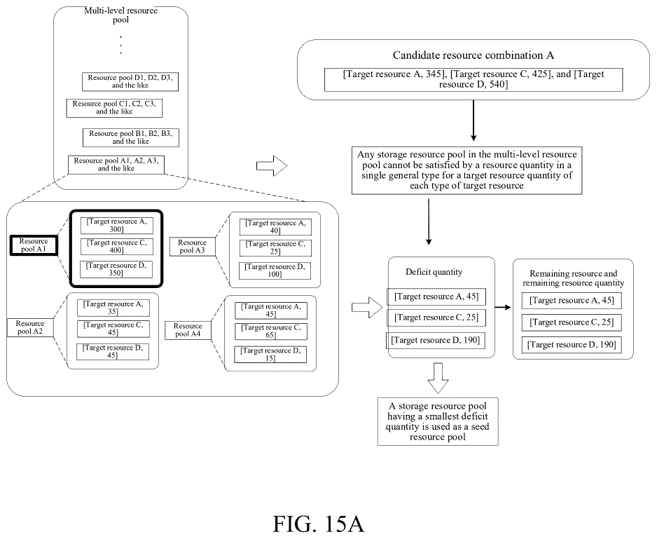

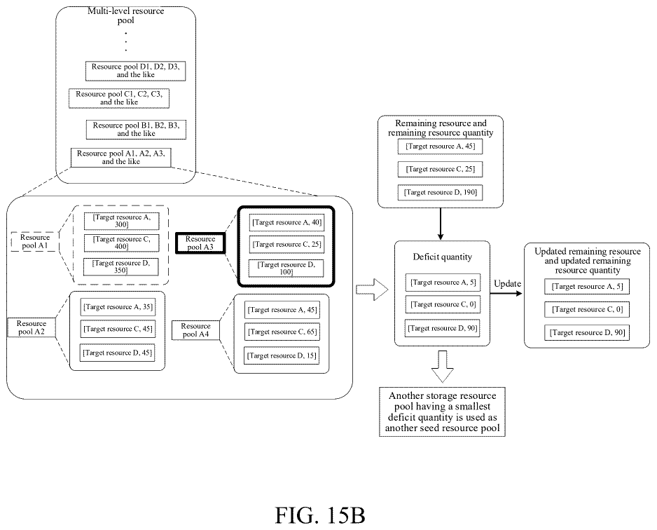

Referring to some embodiments of the present disclosure provided in FIG. 15A and FIG. 15B, a case in which any storage resource pool in the multi-level resource pool cannot be satisfied by the resource quantity in the single general type for the target resource quantity of each type of target resource is shown. Levels of a resource pool level A, a resource pool level B, a resource pool level C, and a resource pool level D sequentially increase. Resource pools of the resource pool level A include a resource pool A1, a resource pool A2, a resource pool A3, and the like. Resource pools of the resource pool level B include a resource pool B1, a resource pool B2, a resource pool B3, and the like. Resource pools of the resource pool level C include a resource pool C1, a resource pool C2, a resource pool C3, and the like. Resource pools of the resource pool level D include a resource pool D1, a resource pool D2, a resource pool D3, and the like.

Referring to FIG. 15A, specifically, the candidate resource combination A in the resource scheduling request needs 345 target resources A, 425 target resources C, and 540 target resources D. Any storage resource pool in the multi-level resource pool cannot be satisfied by the resource quantity in the single general type for the target resource quantity of each type of target resource. In this case, a storage resource pool having a smallest deficit quantity after the resource quantity in the single general type is used to satisfy the target resource quantity needs to be selected from the storage resource pools having the lowest level, namely, the resource pool A1, the resource pool A2, the resource pool A3, and the resource pool A4 of the resource pool level A, as a seed resource pool. It may be clarified that, because the resource pool A1 can satisfy various target resource quantities to a largest extent, a corresponding deficit quantity is the smallest after the resource pool A1 satisfies the target resource quantities. Therefore, the resource pool A1 is determined as the seed resource pool. Then, the single general type is used as a target general type, and a resource quantity that is still not satisfied after the resource quantity in the single general type is used to satisfy the target resource quantity is used as a remaining resource quantity. The remaining resource and the remaining resource quantity are specifically: [target resource A, 45], [target resource C, 25], and [target resource D, 190].

Referring to FIG. 15B, after the remaining resource and the remaining resource quantity are determined, further, in other storage resource pools having the lowest level, the another storage resource pool having the smallest deficit quantity that is obtained after the resource quantity in the target general type is used to satisfy the remaining resource quantity is selected as the seed resource pool. Because in the other storage resource pools having the lowest level, namely, the resource pool A2, the resource pool A3, and the resource pool A4, the resource pool A3 can satisfy various remaining resource quantities to a largest extent, and a corresponding deficit quantity is the smallest after the resource pool A3 satisfies the remaining resource quantities. The deficit quantity may be obtained by subtracting a resource quantity stored in a corresponding resource pool from the remaining resource quantity, and is specifically: [target resource A, 5], [target resource C, 0], and [target resource D, 90]. Therefore, the resource pool A2 having the smallest deficit quantity that is obtained after the resource quantity in the target general type is used to satisfy the remaining resource quantity may be determined as another seed resource pool. In addition, the remaining resource quantity is updated by using the resource quantity that is still not satisfied after the resource quantity in the target general type is used to satisfy the remaining resource quantity.

The storage resource pool having the lowest level is traversed in the foregoing manner, so that a plurality of seed resource pools may be determined. Accordingly, the determined plurality of seed resource pools helps reduce the overall overheads of resource scheduling and improve the efficiency of resource scheduling, and further improve the efficiency of supplementing the target resource quantity.

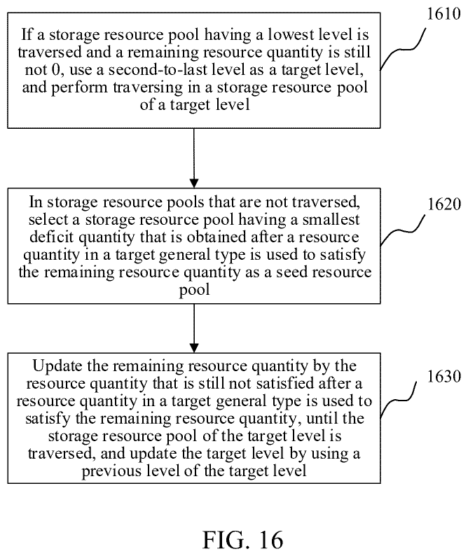

Referring to FIG. 16, after the storage resource pool having the lowest level is traversed in operation 1420, a second process may be further performed in the resource scheduling method in this embodiment of the present disclosure. The second process may include, but is not limited to, the following operation 1610 to operation 1630.

Operation 1610: If the storage resource pool having the lowest level is traversed and the remaining resource quantity is still not 0, use a second-to-last level as a target level, and perform traversing in the storage resource pool of the target level.

Operation 1620: In storage resource pools that are not traversed, select a storage resource pool having a smallest deficit quantity that is obtained after the resource quantity in the target general type is used to satisfy the remaining resource quantity as a seed resource pool.

Operation 1630: Update the remaining resource quantity by using the resource quantity that is still not satisfied after the resource quantity in the target general type is used to satisfy the remaining resource quantity, until the storage resource pool of the target level is traversed, update the target level by using a next level of the target level, and repeat the second process until a highest level is reached.

Operation 1610 to operation 1630 are described in detail below.

In operation 1610 to operation 1630, if the storage resource pool having the lowest level is traversed and the remaining resource quantity is still not 0, the second-to-last level is used as the target level, and traversing is performed in the storage resource pool of the target level. Further, the storage resource pool having the smallest deficit quantity that is obtained after the resource quantity in the target general type is used to satisfy the remaining resource quantity is selected from the storage resource pool that is not traversed as the seed resource pool. Still further, the remaining resource quantity is updated by using the resource quantity that is still not satisfied after the resource quantity in the target general type is used to satisfy the remaining resource quantity, until the storage resource pool of the target level is traversed, the target level is updated by using the next level of the target level, and the second process is repeated until the highest level is reached.

There may be various rating references for levels of the resource pools, the levels of the resource pools increase in ascending order, and overheads caused by resource scheduling of the resource pools sequentially increase. Therefore, if the storage resource pool having the lowest level is traversed and the remaining resource quantity is still not 0, the second-to-last level may be used as the target level, and traversing is performed in the storage resource pool of the target level. An objective is to first satisfy the resource quantity in the single general type as much as possible by using a storage resource pool having a low level, a deficit quantity of a corresponding resource of a resource pool of a second-to-last level is determined, and then the storage resource pool having the smallest deficit quantity is determined as the seed resource pool. The resource pool of the second-to-last level is traversed, for example, in a manner of traversing the resource pool having the lowest level, to supplement the target resource pool. Because the resource pools are sorted in ascending order of levels, overheads caused by resource scheduling of the resource pools sequentially increase. Determining the seed resource pool in this manner helps reduce the overall overheads of resource scheduling and improve the efficiency of resource scheduling.

Similarly, after traversing the second-to-last resource pool is completed, if the remaining resource quantity is still not 0, the target level is updated by using the next level of the target level, and the second process is repeated until the highest level is reached. If the remaining resource quantity is zeroed in a process of being supplemented to the resource pool of the target level, all seed resource pools used to provide the target resource may be determined.

In the embodiments of the present disclosure shown in operation 1610 to operation 1630, because the resource pools are sorted in the ascending order of the levels, the overheads caused by resource scheduling of the resource pools sequentially increase. Preferentially determining the seed resource pool in a plurality of storage resource pools having a low level helps reduce the overall overheads of resource scheduling and improves the efficiency of resource scheduling, and further improves the efficiency of supplementing the target resource quantity.

### Detailed Descriptions of Operation 330

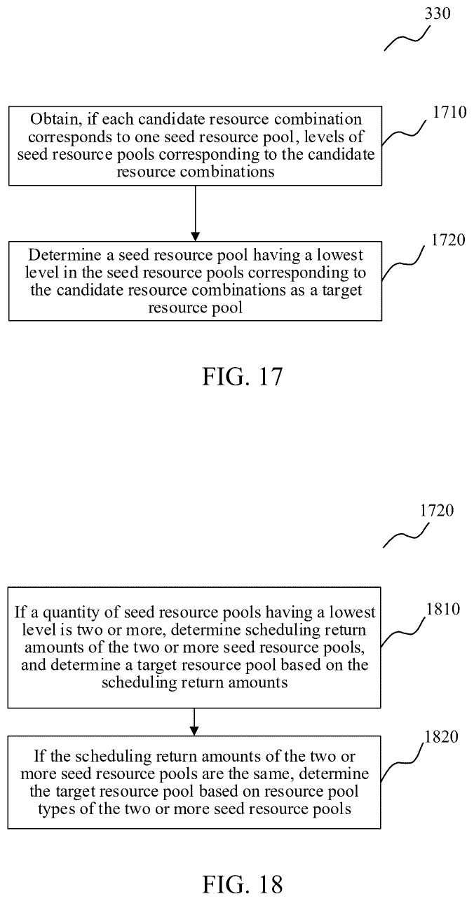

Referring to FIG. 17, operation 330 may include, but is not limited to, the following operation 1710 and operation 1720.

Operation 1710: Obtain, if each candidate resource combination corresponds to one seed resource pool, the levels of the seed resource pools corresponding to the candidate resource combinations.

Operation 1720: Determine a seed resource pool having a lowest level in the seed resource pools corresponding to the candidate resource combinations as the target resource pool.

Operation 1710 and operation 1720 are described in detail below.

In operation 1710, if each candidate resource combination corresponds to one seed resource pool, the levels of the seed resource pools corresponding to the candidate resource combinations are obtained. To determine, in the plurality of seed resource pools, the target resource pool used to satisfy the resource scheduling request, the levels of the seed resource pools corresponding to the candidate resource combinations need to be first obtained, to facilitate preferred selection in the plurality of seed resource pools.

In operation 1720, the seed resource pool having the lowest level in the seed resource pools corresponding to the candidate resource combinations is determined as the target resource pool. Performing resource scheduling based on any candidate resource combination in the plurality of candidate resource combinations can satisfy the resource scheduling request of the target task. However, satisfying the resource scheduling request has a difference in scheduling effects. Because the resource pools are sorted in ascending order of levels, overheads caused by resource scheduling of the resource pools sequentially increase. In the embodiments of the present disclosure, the seed resource pool having the lowest level in the seed resource pools corresponding to the candidate resource combinations is determined as the target resource pool, to reduce overheads generated by resource scheduling and improve the efficiency of resource scheduling.

According to an embodiment of the present disclosure shown in operation 1710 and operation 1720, in this embodiment of the present disclosure, the seed resource pool having the lowest level is preferentially selected and determined as the target resource pool, to help improve the efficiency of resource scheduling.

Referring to FIG. 18, operation 1720 may include, but is not limited to, the following operation 1810 and operation 1820.

Operation 1810: If a quantity of seed resource pools having a lowest level is two or more, determine scheduling return amounts of the two or more seed resource pools, and determine the target resource pool based on the scheduling return amounts.

Operation 1820: If the scheduling return amounts of the two or more seed resource pools are the same, determine the target resource pool based on resource pool types of the two or more seed resource pools.

Operation 1810 and operation 1820 are described in detail below.

In operation 1810, if the quantity of seed resource pools having the lowest level is two or more, the scheduling return amounts of the two or more seed resource pools are determined, and the target resource pool is determined based on the scheduling return amounts. If there are two or more seed resource pools having the lowest level, it means that preferred selection cannot be further performed based only on the levels of the seed resource pools. Based on this, the scheduling return amounts of the two or more seed resource pools may be determined, and the target resource pool is determined based on preferred selection performed based on the scheduling return amounts. The scheduling return amount is a balance amount of a resource pool that needs to be returned in a process of performing resource scheduling by using a storage amount of the resource pool. The scheduling return amount is generated because the resource pool storage amount fails to exactly satisfy the resource scheduling request. Therefore, a smaller scheduling return amount of the resource pool to be checked means lower overheads of returning a balance resource to the resource pool. If the quantity of seed resource pools having the lowest level is two or more, the scheduling return amounts of the two or more seed resource pools are determined, and the target resource pool is determined based on the scheduling return amounts, to reduce the economic costs and the time costs that are generated in the resource scheduling process, and improve the efficiency of resource scheduling.

In operation 1820, if the scheduling return amounts of the two or more seed resource pools are the same, the target resource pool is determined based on the resource pool types of the two or more seed resource pools. If the quantity of seed resource pools having the lowest level is two or more, and the scheduling return amounts of the two or more seed resource pools are the same, it means that preferred selection cannot be further performed based on the levels of the seed resource pools and the scheduling return amounts of the seed resource pools. The resource pool types may include a plurality of classification standards, for example, a resource pool type obtained by performing classification based on a capacity scale, a resource pool type obtained by performing classification based on a remaining storage amount, a resource pool type obtained by performing classification based on a resource scheduling permission, and various other resource pool types.

According to this embodiment of the present disclosure shown in operation 1810 and operation 1820, to determine the target resource pool from the two or more seed resource pools, preferred selection needs to be first performed on the two or more seed resource pools based on the resource pool levels, and a seed resource pool having a low level is determined as the target resource pool. If the corresponding levels of the two or more seed resource pools are the same, preferred selection is then performed on the two or more seed resource pools based on the scheduling return amounts. If the corresponding levels of the two or more seed resource pools are the same, and the scheduling return amounts are also the same, preferred selection is performed based on the resource pool types of the two or more seed resource pools, to finally determine the target resource pool. Accordingly, the target resource pool may be selected from the two or more seed resource pools, to further reduce the costs of resource scheduling, and improve the efficiency of resource scheduling.

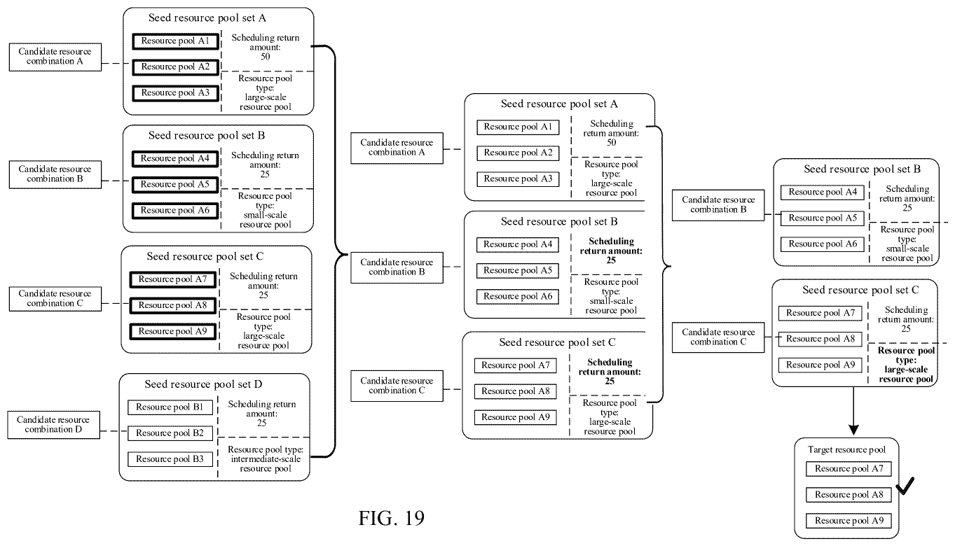

Referring to FIG. 19, according to some embodiments provided in the present disclosure, levels of a resource pool level A, a resource pool level B, a resource pool level C, and a resource pool level D sequentially increase. Resource pools of the resource pool level A include a resource pool A1, a resource pool A2, a resource pool A3, and the like. Resource pools of the resource pool level B include a resource pool B1, a resource pool B2, a resource pool B3, and the like. Resource pools of the resource pool level C include a resource pool C1, a resource pool C2, a resource pool C3, and the like. Resource pools of the resource pool level D include a resource pool D1, a resource pool D2, a resource pool D3, and the like.

A seed resource pool corresponding to a candidate resource combination A is included in a seed resource pool set A, which includes the resource pool A1, the resource pool A2, and the resource pool A3, a corresponding resource return amount is 50, and a resource pool type is “a large-scale resource pool”.

A seed resource pool corresponding to a candidate resource combination B is included in a seed resource pool set B, which includes the resource pool A4, the resource pool A5, and the resource pool A6, a corresponding resource return amount is 25, and a resource pool type is “a large-scale resource pool”.

A seed resource pool corresponding to a candidate resource combination C is included in a seed resource pool set C, which includes the resource pool A7, the resource pool A8, and the resource pool A9, a corresponding resource return amount is 25, and a resource pool type is “a large-scale resource pool”.

A seed resource pool corresponding to a candidate resource combination D is included in a seed resource pool set D, which includes the resource pool B1, the resource pool B2, and the resource pool B3, a corresponding resource return amount is 25, and a resource pool type is “a large-scale resource pool”.

FIG. 19 shows an example implementation of determining a target resource pool in a plurality of seed resource pools.

To determine the target resource pool from the plurality of seed resource pools, preferred selection need to be performed on the plurality of seed resource pools based on resource pool levels, and a seed resource pool having a low level is determined as the target resource pool. Specifically, resource pool levels of a seed resource pool set A, a seed resource pool set B, and a seed resource pool set C are all resource pool levels A, and a resource pool level of a candidate resource combination D is a resource pool level B. On a premise that the resource pool level A is lower than the resource pool level B, seed resource pools preferentially selected based on the resource pool levels are specifically seed resource pools in the seed resource pool set A, the seed resource pool set B, and the seed resource pool set C.

Further, because corresponding levels of a plurality of seed resource pools are the same, preferred selection needs to be performed on the two or more seed resource pools based on the scheduling return amount. In the seed resource pool set A, the seed resource pool set B, and the seed resource pool set C, a scheduling return amount of the seed resource pool set A is 50, and a scheduling return amount of the seed resource pool set B and a scheduling return amount of the seed resource pool set C are 25. Therefore, the seed resource pool set B whose scheduling return amount is 25 and the seed resource pool set C whose scheduling return amount is 25 are preferentially selected.

Further, because the corresponding levels of the plurality of seed resource pools are the same, and the scheduling return amounts are also the same, preferred selection needs to be performed on the plurality of seed resource pools based on the resource pool type. In some embodiments, compared with a small-scale resource pool, a large-scale resource pool has a more perfect resource scheduling system, a more standard resource scheduling procedure, and a more efficient resource scheduling channel. Therefore, preferred selection is performed on the seed resource pool set B and the seed resource pool set C based on the resource pool type, and the seed resource pool set C of the large-scale resource pool type is selected.

It may be clarified that, after three-layer selection is performed, a seed resource pool in the seed resource pool set C is then determined as the target resource pool. In response to the resource scheduling request of the target task, a candidate resource combination C corresponding to the seed resource pool set C is also used as a resource combination used for resource scheduling. Accordingly, the target resource pool may be selected from the two or more seed resource pools, to further reduce the costs of resource scheduling, and improve the efficiency of resource scheduling.

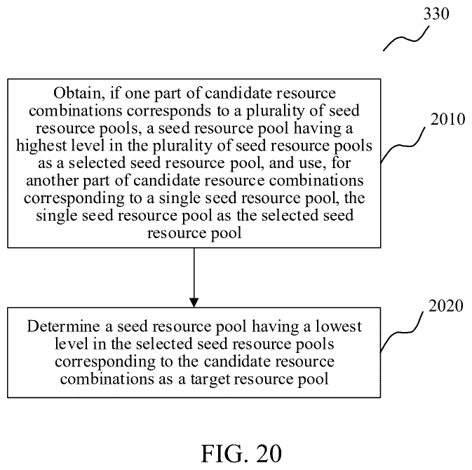

Referring to FIG. 20, operation 330 may further include, but is not limited to, the following operation 2010 and operation 2020.

Operation 2010: Obtain, if one part of candidate resource combinations corresponds to the plurality of seed resource pools, a seed resource pool having a highest level in the plurality of seed resource pools as a selected seed resource pool, and use, for the other part of candidate resource combinations corresponding to a single seed resource pool, the single seed resource pool as the selected seed resource pool.

Operation 2020: Determine a seed resource pool having a lowest level in the selected seed resource pools corresponding to the candidate resource combinations as the target resource pool.

Operation 2010 and operation 2020 are described in detail below.

In the process of determining, in the plurality of seed resource pools based on the levels of the seed resource pools corresponding to the candidate resource combinations, the target resource pool used to satisfy the resource scheduling request, if some candidate resource combinations correspond to the plurality of seed resource pools, and the resource pool levels of the plurality of seed resource pools are inconsistent, the target resource pool may be determined according to the embodiments of the present disclosure shown in operation 2010 and operation 2020.

In operation 2010 and operation 2020, if one part of candidate resource combinations corresponds to the plurality of seed resource pools, the seed resource pool having the highest level in the plurality of seed resource pools is obtained as the selected seed resource pool, and for another part of candidate resource combinations corresponding to the single seed resource pool, the single seed resource pool is used as the selected seed resource pool. Further, the seed resource pool having the lowest level in the selected seed resource pools corresponding to the candidate resource combinations is determined as the target resource pool. The selected seed resource pool of the candidate resource combination is used to perform preferred selection on the seed resource pools corresponding to the candidate resource combinations. When the candidate resource combination corresponds to the single seed resource pool, the single seed resource pool may be directly used as the selected seed resource pool. When the candidate resource combination corresponds to a plurality of seed resource pools, and resource pool levels of the plurality of seed resource pools are inconsistent, a seed resource pool having a highest level needs to be determined from the plurality of seed resource pools corresponding to the candidate resource combination, and is used as the selected seed resource pool. Accordingly, comparison of resource pool levels may be performed between different candidate combinations based on the selected seed resource pools, so that the seed resource pool having the lowest level in the selected seed resource pools corresponding to the candidate resource combinations is determined as the target resource pool.

According to the embodiments of the present disclosure shown in operation 2010 and operation 2020, when the candidate resource combination corresponds to the plurality of seed resource pools and the resource pool levels of the plurality of seed resource pools are inconsistent, the target resource pool used to satisfy the resource scheduling request can be determined in the plurality of seed resource pools based on the levels of the seed resource pools corresponding to the candidate resource combinations, to help further reduce the costs of resource scheduling and improve the efficiency of resource scheduling.

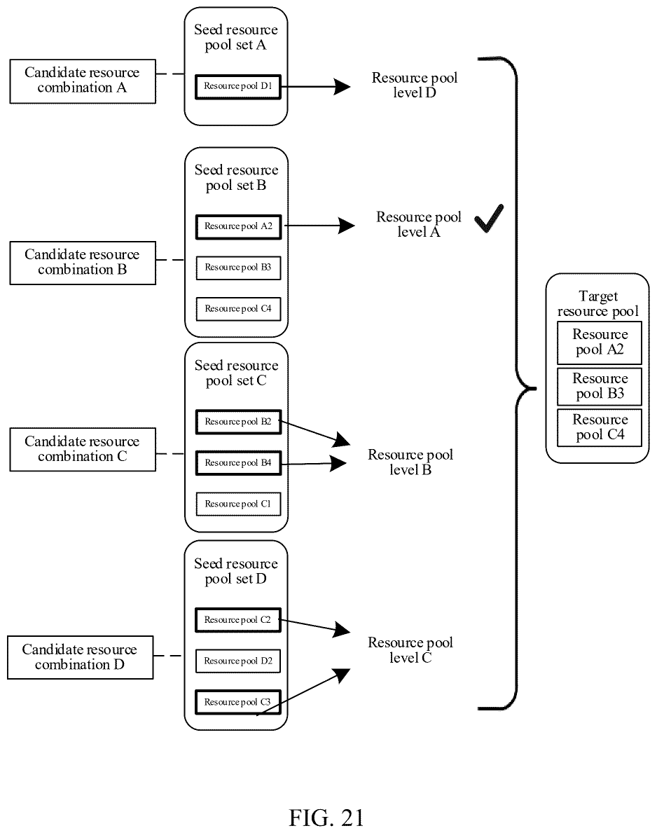

Referring to an embodiment of the present disclosure shown in FIG. 21, levels of a resource pool level A, a resource pool level B, a resource pool level C, and a resource pool level D sequentially increase. Resource pools of the resource pool level A include a resource pool A1, a resource pool A2, a resource pool A3, and the like. Resource pools of the resource pool level B include a resource pool B1, a resource pool B2, a resource pool B3, and the like. Resource pools of the resource pool level C include a resource pool C1, a resource pool C2, a resource pool C3, and the like. Resource pools of the resource pool level D include a resource pool D1, a resource pool D2, a resource pool D3, and the like.

A seed resource pool corresponding to a candidate resource combination A is included in a seed resource pool set A, which includes the resource pool D1.

A seed resource pool corresponding to a candidate resource combination B is included in a seed resource pool set B, which includes the resource pool A2, the resource pool B3, and the resource pool C4.

A seed resource pool corresponding to a candidate resource combination C is included in a seed resource pool set C, which includes the resource pool B2, the resource pool B4, and the resource pool C1.

A seed resource pool corresponding to a candidate resource combination D is included in a seed resource pool set D, which includes the resource pool C2, the resource pool D2, and the resource pool C3.

FIG. 21 shows an embodiment of how to determine a target resource pool when a candidate resource combination corresponds to a plurality of seed resource pools, and resource pool levels of the plurality of seed resource pools are not consistent. Specifically, the candidate resource combination A corresponds to the single seed resource pool, namely, the resource pool D1. Therefore, the single seed resource pool may be used as the selected seed resource pool.

The candidate resource combination B corresponds to three seed resource pools: the resource pool A2, the resource pool B3, and the resource pool C4. Therefore, a seed resource pool having a highest level, namely, the resource pool A2, is obtained from the three seed resource pools, and is used as the selected seed resource pool.

The candidate resource combination C corresponds to three seed resource pools: the resource pool B2, the resource pool B4, and the resource pool C1. Therefore, a seed resource pool having a highest level, namely, the resource pool B2 or the resource pool B4, is obtained from the three seed resource pools, and is used as the selected seed resource pool.

The candidate resource combination B corresponds to three seed resource pools: the resource pool C2, the resource pool D2, and the resource pool C3. Therefore, a seed resource pool having a highest level, namely, the resource pool C2 or the resource pool C3, is obtained from the three seed resource pools, and is used as the selected seed resource pool.

Further, the seed resource pool having the lowest level in the selected seed resource pools corresponding to the candidate resource combinations is determined as the target resource pool. Specifically, a seed resource pool having a lowest level, namely, the resource pool A2, in the resource pool D1, the resource pool A2, the resource pool B2, the resource pool B4, the resource pool C2, and the resource pool C3 is determined as the target resource pool. Accordingly, when the candidate resource combinations correspond to the plurality of seed resource pools and the resource pool levels of the plurality of seed resource pools are inconsistent, the target resource pool used to satisfy the resource scheduling request can be determined in the plurality of seed resource pools based on the levels of the seed resource pools corresponding to the candidate resource combinations, to help further reduce the costs of resource scheduling and improve the efficiency of resource scheduling.

### Detailed Descriptions of a Feasible Implementation Before Operation 310

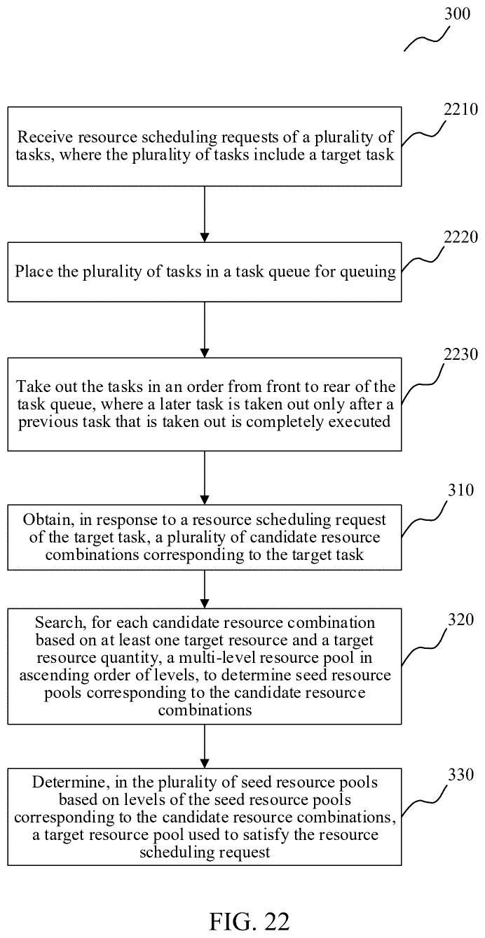

Referring to FIG. 22, according to some embodiments provided in the present disclosure, before operation 310, the resource scheduling method in the embodiments of the present disclosure may further include, but is not limited to, the following operation 2210 to operation 2230.

Operation 2210: Receive resource scheduling requests of a plurality of tasks, where the plurality of tasks include the target task;
operation 2220: Place the plurality of tasks in a task queue for queuing; and
operation 2230: Take out the tasks in an order from front to rear of the task queue, where a later task is taken out only after a previous task that is taken out is completely executed.

Operation 2210 to operation 2230 are described in detail below.

In operation 2210, the resource scheduling requests of the plurality of tasks are received, where the plurality of tasks include the target task. In many service scenarios, usually resources need to be scheduled for a plurality of tasks. In this case, resource scheduling requests of the plurality of tasks need to be received first, to facilitate subsequent operations to be performed for scheduling the resources for the tasks.

In operation 2220 and operation 2230, the plurality of tasks are placed in the task queue for queuing, and the tasks are taken out in the order from front to rear of the task queue, where the later task is taken out only after the previous task that is taken out is completely executed. Considering that different tasks may use the same resource in the same resource pool, if parallel resource scheduling is simultaneously performed on the tasks, resource competition may be caused, affecting the efficiency of resource scheduling. To this end, in the embodiments of the present disclosure, the plurality of tasks need to be placed in the task queue for queuing, and the tasks are taken out in the order from front to rear of the task queue, where the later task is taken out only after the previous task that is taken out is completely executed.

In the embodiments of the present disclosure shown in operation 2210 to operation 2230, the resource scheduling requests of the plurality of tasks are received, where the plurality of tasks include the target task, the plurality of tasks are placed in the task queue for queuing, and the tasks are taken out in the order from front to rear of the task queue, where the later task is taken out only after the previous task that is taken out is completely executed. Accordingly, the tasks may be arranged into a serial queue, and resource scheduling is sequentially performed on each task, which can further improve the efficiency of resource scheduling.

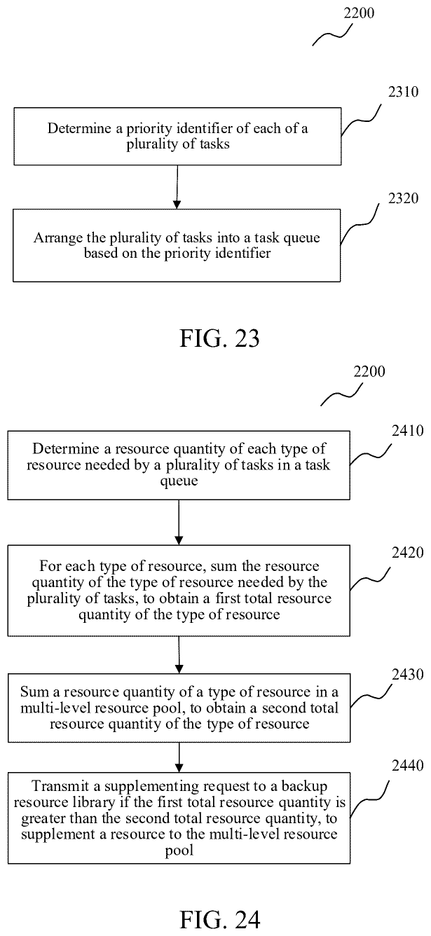

Referring to FIG. 23, according to some embodiments provided in the present disclosure, operation 2220 may include, but is not limited to, the following operation 2310 and operation 2320.

Operation 2310: Determine a priority identifier of each of the plurality of tasks; and

Operation 2320: Arrange the plurality of tasks into the task queue based on the priority identifier.

Operation 2310 and operation 2320 are described in detail below.

In operation 2310 and operation 2320, the priority identifier of each of the plurality of tasks is determined. Further, the plurality of tasks are arranged into the task queue based on the priority identifier. When the plurality of tasks are queued for resource scheduling, the plurality of tasks need to be placed in the task queue for queuing. Some tasks need to be preferentially executed, and therefore need to be placed at the head of the task queue during queuing. A priority identifier configured by a task is used to represent a priority level corresponding to a current task, where a task having a high priority level is preferentially taken out in an order in which the task ranks top in the task queue, and a task having a low priority level is taken out in an order in which the task ranks bottom in the task queue.

In the embodiments of the present disclosure shown in operation 2310 and operation 2320, the priority identifier of each of the plurality of tasks is first determined, and then the plurality of tasks are arranged into the task queue based on the priority identifier. Accordingly, a resource scheduling order can be properly determined based on priorities of different tasks, so that the efficiency of resource scheduling and the flexibility of resource scheduling can be further improved.

Referring to FIG. 24, according to some embodiments provided in the present disclosure, after operation 2220, the resource scheduling method in the embodiments of the present disclosure may further include, but is not limited to, the following operation 2410 to operation 2440.

Operation 2410: Determine a resource quantity of each type of resource needed by the plurality of tasks in the task queue;
operation 2420: For each type of resource, sum the resource quantity of the type of resource needed by the plurality of tasks, to obtain a first total resource quantity of the type of resource;
operation 2430: Sum a resource quantity of the type of resource in the multi-level resource pool, to obtain a second total resource quantity of the type of resource; and
operation 2440: Transmit a supplementing request to a backup resource library if the first total resource quantity is greater than the second total resource quantity, to supplement a resource to the multi-level resource pool.

Operation 2410 to operation 2440 are described in detail below.

In some embodiments, the resource scheduling requests of the plurality of tasks need to be first received, where the plurality of tasks include the target task, the plurality of tasks are placed in the task queue for queuing, and the tasks are taken out in the order from front to rear of the task queue, where the later task is taken out only after the previous task that is taken out is completely executed. In this process, if resources in the multi-level resource pool are starved, resource scheduling for a current task needs to be suspended, and normal resource scheduling may be resumed until supplement of the resource to the multi-level resource pool is completed. If resource scheduling is suspended, the efficiency of resource scheduling for each task in the task queue may be reduced. To resolve this problem, the embodiments of the present disclosure provide embodiments shown in operation 2410 to operation 2440.

In operation 2410, the resource quantity of each type of resource needed by the plurality of tasks in the task queue is determined. The task queue may include the plurality of tasks, and each task needs scheduling of a plurality of resources. Therefore, to clarify a requirement for resources in the task queue, the resource quantity of each type of resource needed by the plurality of tasks in the task queue needs to be determined first.

In operation 2420, for each type of resource, the resource quantity of the type of resource needed by the plurality of tasks is summed, to obtain the first total resource quantity of the type of resource. The plurality of tasks in the task queue may have requirements on the same type of resource, and therefore, for each type of resource, the resource quantity of the type of resource needed by the plurality of tasks is summed, to obtain the first total resource quantity of the type of resource. The first total resource quantity may reflect a total requirement quantity of the tasks in the current task queue for a resource.

In operation 2430, the resource quantity of the type of resource in the multi-level resource pool is summed, to obtain the second total resource quantity of the type of resource. To determine whether a remaining quantity that is sufficient to cover the requirement of the current task queue in the multi-level resource pool, the resource quantity of the type of resource in the multi-level resource pool is summed, to obtain the second total resource quantity of the type of resource. The second total resource quantity may reflect a total remaining quantity of a resource in the current multi-level resource pool.

In operation 2440, the supplementing request is transmitted to the backup resource library if the first total resource quantity is greater than the second total resource quantity, to supplement the resource to the multi-level resource pool. The first total resource quantity reflects a total requirement quantity of the tasks in the current task queue for a resource, and the second total resource quantity reflects a total remaining quantity of a resource in the current multi-level resource pool. Therefore, if the first total resource quantity is greater than the second total resource quantity, it means that the multi-level resource pool has a poor remaining storage quantity of the type of resource, and therefore, the multi-level resource pool needs to transmit the supplementing request to the backup resource library, to supplement the resource to the multi-level resource pool. The backup resource library is a resource storage unit other than the multi-level resource pool.

In the embodiments of the present disclosure shown in operation 2410 to operation 2440, if a first total resource quantity of a specific type of resource is greater than a second total resource quantity of a specific type of resource, it is determined that the multi-level resource pool has a poor remaining storage quantity of the type of resource, and therefore, the multi-level resource pool transmits the supplementing request to the backup resource library, to enable the backup resource library to supplement the resource to the multi-level resource pool. Accordingly, a possibility that resource scheduling is suspended can be reduced, and the efficiency of resource scheduling is further improved.

In some embodiments, because it takes some time to supplement the resource to the multi-level resource pool from the backup resource library, supplementing a storage resource whose quantity exceeds the first total resource quantity to the multi-level resource pool, so that a possibility that resource scheduling is suspended can be further reduced. For example, the first total resource quantity is greater than the second total resource quantity, which specifically may be that when the second total resource quantity is less than several times of the first total resource quantity, it may be determined that the supplementing request needs to be transmitted to the backup resource library, so that the backup resource library supplements the resource to the multi-level resource pool.

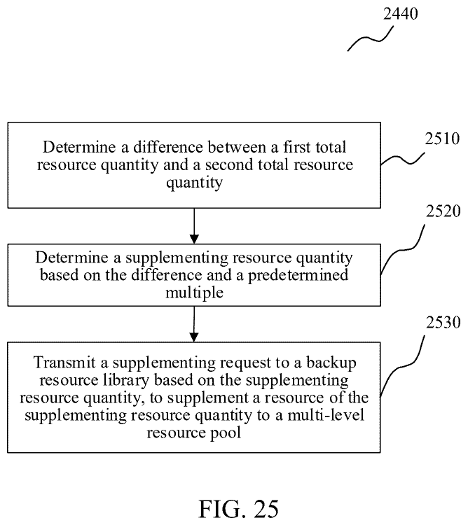

Referring to FIG. 25, according to some embodiments provided in the present disclosure, operation 2440 may include, but is not limited to, the following operation 2510 to operation 2530.

Operation 2510: Determine a difference between the first total resource quantity and the second total resource quantity;
operation 2520: Determine a supplementing resource quantity based on the difference and a predetermined multiple; and
operation 2530: Transmit a supplementing request to a backup resource library based on the supplementing resource quantity, to supplement a resource of the supplementing resource quantity to the multi-level resource pool.

Operation 2510 to operation 2530 are described in detail below.

In operation 2510 to operation 2530, the difference between the first total resource quantity and the second total resource quantity is first determined; further, the supplementing resource quantity is determined based on the difference and the predetermined multiple; and further, the supplementing request is transmitted to the backup resource library based on the supplementing resource quantity, to supplement the resource of the supplementing resource quantity to the multi-level resource pool. Because it takes some time to supplement the resource from the backup resource library to the multi-level resource pool, supplementing the storage resource whose quantity exceeds the first total resource quantity to the multi-level resource pool, so that the possibility that resource scheduling is suspended can be further reduced. To this end, in the embodiments of the present disclosure, the difference between the first total resource quantity and the second total resource quantity needs to be first determined, and then the predetermined multiple is multiplied by the difference between the first total resource quantity and the second total resource quantity, to determine the corresponding supplementing resource quantity. Based on this, the supplementing request is transmitted to the backup resource library based on the supplementing resource quantity, to further reduce a probability that resource scheduling is suspended.

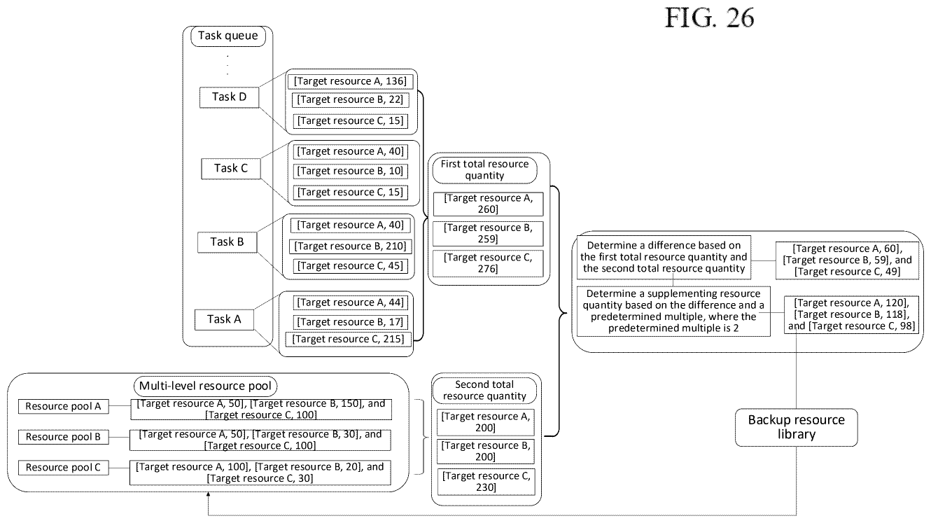

Referring to some embodiments of the present disclosure provided in FIG. 26, FIG. 26 shows an example implementation of transmitting a supplementing request to a backup resource library, to supplement a resource to a multi-level resource pool.

A task queue includes a task A, a task B, a task C, and a task D. Each task needs a target resource A, a target resource B, and a target resource C. For each type of resource, a resource quantity of the type of resource needed by the plurality of tasks is summed, to obtain a first total resource quantity of the type of resource. It may be determined that a first total resource quantity of the target resource A is 160, a first total resource quantity of the target resource B is 59, and a first total resource quantity of the target resource C is 76.

In addition, the multi-level resource pool also includes three resource pools: a resource pool A, a resource pool B, and a resource pool C. It may be determined that a second total resource quantity of the target resource A is 200, a second total resource quantity of the target resource B is 200, and a second total resource quantity of the target resource Cis 230.

After the first total resource quantity and the second total resource quantity of the various types of resources are determined, whether the first total resource quantity is greater than the second total resource quantity needs to be further determined, to determine whether a supplementing request needs to be transmitted to the backup resource library. Because the first total resource quantity of the target resource A, the first total resource quantity of the target resource B, and the first total resource quantity of the target resource C are all greater than the second total resource quantity of the target resource A, the second total resource quantity of the target resource B, and the second total resource quantity of the target resource C, resource supplementing needs to be performed on all the three resources.

Still further, a difference between the first total resource quantity and the second total resource quantity is first determined. A difference between the first total resource quantity of the target resource A and the second total resource quantity of the target resource A is 60, a difference between the first total resource quantity of the target resource B and the second total resource quantity of the target resource B is 59, and a difference between the first total resource quantity of the target resource C and the second total resource quantity of the target resource C is 49. The predetermined multiple is 2, which means that twice as many resources need to be supplemented to the multi-level resource pool based on the difference between the first total resource quantity and the second total resource quantity. Therefore, a supplementing resource quantity of the target resource A is 120, a supplementing resource quantity of the target resource B is 118, and a supplementing resource quantity of the target resource C is 98.

The supplementing request is transmitted to the backup resource library based on the supplementing resource quantity 120 of the target resource A, the supplementing resource quantity 118 of the target resource B, and the supplementing resource quantity 98 of the target resource C, so that the backup resource library supplements the resource of the supplementing resource quantity to the multi-level resource pool. Accordingly, a possibility that resource scheduling is suspended can be further reduced.

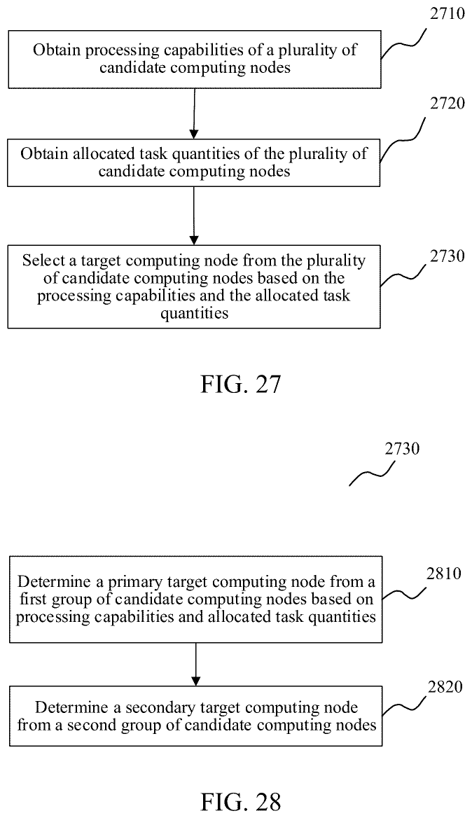

Referring to FIG. 27, according to some embodiments provided in the present disclosure, the resource scheduling method in the present disclosure may be performed by a target computing node in a plurality of candidate computing nodes, and the target computing node is selected from the plurality of candidate computing nodes in the following manner:

Operation 2710: Obtain processing capabilities of the plurality of candidate computing nodes;
operation 2720: Obtain allocated task quantities of the plurality of candidate computing nodes; and
operation 2730: Select the target computing node from the plurality of candidate computing nodes based on the processing capabilities and the allocated task quantities.

Operation 2710 to operation 2730 are described in detail below.

In operation 2710 to operation 2730, first, processing capabilities of the plurality of candidate computing nodes are obtained, then, the allocated task quantities of the plurality of candidate computing nodes are obtained, and the target computing node is further selected from the plurality of candidate computing nodes based on the processing capabilities and the allocated task quantities. The computing node is configured to provide computing power needed in a resource scheduling process, the candidate computing node is a preset computing node that may be selected to provide computing power for resource scheduling, and the target computing node is selected from the plurality of candidate computing nodes. Specifically, to select the target computing node from the plurality of candidate computing nodes, the allocated task quantities of the plurality of candidate computing nodes need to be first obtained, and then the target computing node is selected from the plurality of candidate computing nodes based on the processing capabilities and the allocated task quantities An objective is that based on the processing capability and the allocated task quantity of the candidate computing node, computing power that can be currently invested by the candidate computing node in a resource scheduling processing process may be determined, so that in the resource scheduling process, much computing power can be obtained from the corresponding computing node, to further improve the efficiency of resource scheduling.

Referring to FIG. 28, according to some embodiments provided in the present disclosure, the target computing node includes a primary target computing node and a secondary target computing node, and the plurality of candidate computing nodes include a first group of candidate computing nodes and a second group of candidate computing nodes. Operation 2730 may include, but is not limited to, the following operation 2810 and operation 2820.

Operation 2810: Determine the primary target computing node from the first group of candidate computing nodes based on the processing capabilities and the allocated task quantities; and
operation 2820: Determine the secondary target computing node from the second group of candidate computing nodes.

Operation 2810 and operation 2820 are described in detail below.

The target computing node is a computing node selected to provide computing power for resource scheduling. In an embodiment in which the target computing node is selected from the plurality of candidate computing nodes based on the processing capabilities and the allocated task quantities, if the target computing node is faulty, the target computing node may be difficult to support the computing power needed for resource scheduling, and performance in anti-interference and robustness is poor. To resolve this problem, the embodiments of the present disclosure provide embodiments shown in operation 2810 and operation 2820.

In operation 2810, the primary target computing node is determined from the first group of candidate computing nodes based on the processing capabilities and the allocated task quantities. Based on a processing capability and an allocated task quantity of a candidate computing node, computing power that can be currently invested by the candidate computing node in a resource scheduling processing process may be determined. In some embodiments, candidate computing nodes with relatively good processing capabilities or relatively small allocated task quantities may be determined as the first group of candidate computing nodes. Based on this, and based on the processing capabilities and the allocated task quantities, the primary target computing node is determined from the first group of candidate computing nodes, so that the primary target computing node can use much computing power.

In operation 2820, the secondary target computing node is determined from the second group of candidate computing nodes. The part of candidate computing nodes with general processing capabilities or large allocated task quantities may be determined as the second group of candidate computing nodes. Based on this, the secondary target computing node is determined from the second group of candidate computing nodes. Accordingly, a backup solution may be provided for the primary target computing node. When the primary target computing node is faulty, the secondary target computing node may replace the primary target computing node for use, to continuously provide needed computing power for resource scheduling.

According to the embodiments of the present disclosure shown in operation 2810 and operation 2820, a risk that computing power is not supported when some target computing nodes are faulty is reduced, and an anti-interference capability and robustness of the resource scheduling method in the embodiments of the present disclosure are improved.

According to some embodiments of the present disclosure, the target computing node may be configured with corresponding attribute information. In a process of performing the resource scheduling method in the present disclosure through the target computing node, if the primary target computing node is faulty, a secondary target computing node having same attribute information may be preferentially invoked to replace the primary target computing node for use, to continuously provide needed computing power for resource scheduling. An objective is to replace the primary target computing node with the secondary target computing node with the same attribute information, so that adaptation costs caused in a replacement process can be reduced, and occurrence of a possibility of a compatibility problem can be reduced. The attribute information may include information about various aspects such as location information of the target computing node, system configuration information, the processing capability, and the allocated task quantity.

In some embodiments, a quantity of candidate computing nodes is periodically changed in the following manner:
obtaining a total task quantity of a resource platform in a current period; and
determining the quantity of candidate computing nodes based on the total task quantity.

The plurality of candidate computing nodes may be simultaneously configured to respectively respond to resource scheduling requests of different tasks. Therefore, to flexibly handle the resource scheduling requests of the different tasks, the quantity of candidate computing nodes in the embodiments of the present disclosure needs to be periodically changed. When there are few resource scheduling requests, a quantity of candidate computing nodes is reduced, and when there are many resource scheduling requests, a quantity of candidate computing nodes is expanded, to satisfy a calculation requirement. Therefore, a total task quantity of a resource platform in a current period is first obtained, and then the quantity of candidate computing nodes is determined based on the total task quantity. Accordingly, the resource scheduling requests of the different tasks can be flexibly handled.

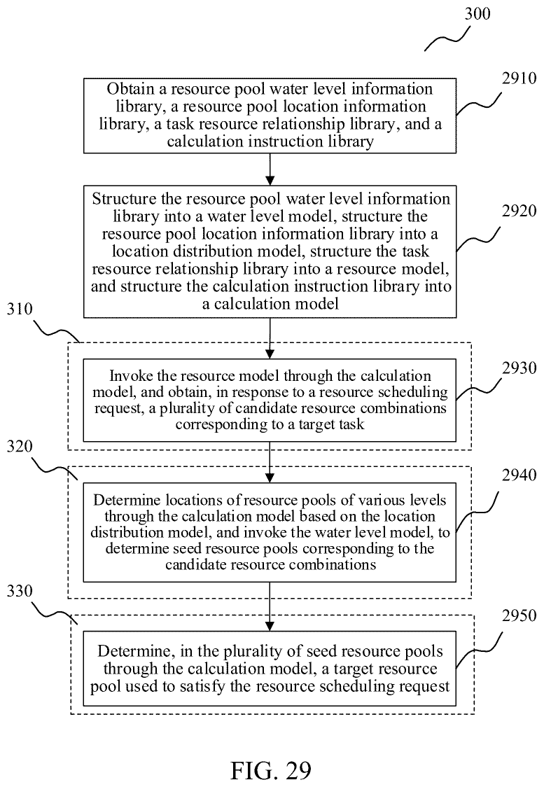

Referring to FIG. 29, according to some embodiments provided in the present disclosure, before operation 310, the resource scheduling method may further include, but is not limited to, the following operation 2910 and operation 2920.

Operation 2910: Obtain a resource pool water level information library, a resource pool location information library, a task resource relationship library, and a calculation instruction library; and
operation 2920: Structure the resource pool water level information library into a water level model, structure the resource pool location information library into a location distribution model, structure the task resource relationship library into a resource model, and structure the calculation instruction library into a calculation model.

Operation 310 may include, but is not limited to, the following operation 2930.

Operation 2930: Invoke the resource model through the calculation model, and obtain, in response to the resource scheduling request, the plurality of candidate resource combinations corresponding to the target task.

Operation 320: Search the multi-level resource pool in the ascending order of the levels, which may include, but is not limited to operation 2940.

Operation 2940: Determine locations of resource pools of various levels through the calculation model based on the location distribution model, and invoke the water level model, to determine the seed resource pools corresponding to the candidate resource combinations.

Operation 330: Determine, in the plurality of seed resource pools, a target resource pool used to satisfy the resource scheduling request, which may include, but is not limited to operation 2950.

Operation 2950: Determine, in the plurality of seed resource pools through the calculation model, the target resource pool used to satisfy the resource scheduling request. Operation 2910 to operation 2950 are described in detail below.

In operation 2910, the resource pool water level information library, the resource pool location information library, the task resource relationship library, and the calculation instruction library are obtained. The resource pool water level information library is used to store resource inventory information of resource pools of various levels. As resource scheduling is continuously performed, resource inventory information in the resource pool is less, that is, a water level of the resource pool is lower. In some embodiments, the target task corresponds to a scheduling target location at which a resource needs to be filled. A longer distance between a location of the resource pool and the scheduling target location indicates larger overheads caused by resource scheduling. Therefore, the location of the resource pool needs to be recorded in the resource pool location information library, to retrieve the location of the resource pool from the resource pool location information library during calculation of overheads. The task resource relationship library stores correspondences between various types of tasks and resources needed by the tasks. The calculation instruction library stores instructions needed for performing calculation processing on various types of data.

In operation 2920, the resource pool water level information library is structured into the water level model, the resource pool location information library is structured into the location distribution model, the task resource relationship library is structured into the resource model, and the calculation instruction library is structured into the calculation model. The resource pool water level information library is structured into the water level model, the resource pool location information library is structured into the location distribution model, the task resource relationship library is structured into the resource model, and the calculation instruction library is structured into the calculation model. An objective is that the computing node conveniently invokes needed data from various models.

In operation 2930, the resource model is invoked through the calculation model, and in response to the resource scheduling request, the plurality of candidate resource combinations corresponding to the target task are obtained. The task resource relationship library stores correspondences between various types of tasks and the resources needed by the tasks, and the task resource relationship library is structured as the resource model. Therefore, in response to the resource scheduling request of the target task, the resource model needs to be invoked through the calculation model to obtain the plurality of candidate resource combinations corresponding to the target task, where each candidate resource combination includes at least one target resource needed by the target task and a target resource quantity of the target resource.

In operation 2940, the locations of the resource pools of the various levels are determined through the calculation model based on the location distribution model, and the water level model is invoked, to determine the seed resource pools corresponding to the candidate resource combinations. The calculation instruction library is used to store instructions needed for performing calculation processing on various types of data, the resource pool location information library is used to store the locations of the resource pools of the various levels, and the resource pool water level information library is used to store the resource inventory information of the resource pools of various levels. In addition, the resource pool water level information library is structured as the water level model, the resource pool location information library is structured as the location distribution model, and the calculation instruction library is structured as the calculation model. Therefore, the locations of the resource pools of the various levels need to be determined through the calculation model based on the location distribution model. An objective is that, for each candidate resource combination based on the at least one target resource and the target resource quantity, the multi-level resource pool is searched in ascending order of levels, and the water level model is invoked, to determine the seed resource pools corresponding to the candidate resource combinations. It needs to be clarified that, in some embodiments, the resource pool levels of the resource pools are divided based on distances between the locations of the resource pools and the scheduling target location. Closer distances between the locations of the resource pools and the scheduling target location correspond to lower resource pool levels, and farther distances between the locations of the resource pools and the scheduling target location correspond to higher resource pool levels.

In operation 2950, in the plurality of seed resource pools through the calculation model, the target resource pool used to satisfy the resource scheduling request is determined. After the seed resource pools corresponding to the candidate resource combinations are determined, the target resource pool used to satisfy the resource scheduling request may be determined in the plurality of seed resource pools through the calculation model. Specifically, in the plurality of seed resource pools based on the levels of the seed resource pools corresponding to the candidate resource combinations, the target resource pool used to satisfy the resource scheduling request is determined through the calculation model.

According to the embodiments of the present disclosure shown in operation 2910 to operation 2950, based on the resource pool water level information library, the resource pool location information library, the task resource relationship library, and the calculation instruction library, the resource scheduling method in the embodiments of the present disclosure is structured as a resource scheduling method implemented based on the water level model, the location distribution model, the resource model, and the calculation model, and functions of the models in the resource scheduling process are clearly determined. Accordingly, it may be convenient to implement the resource scheduling method in the embodiments of the present disclosure.

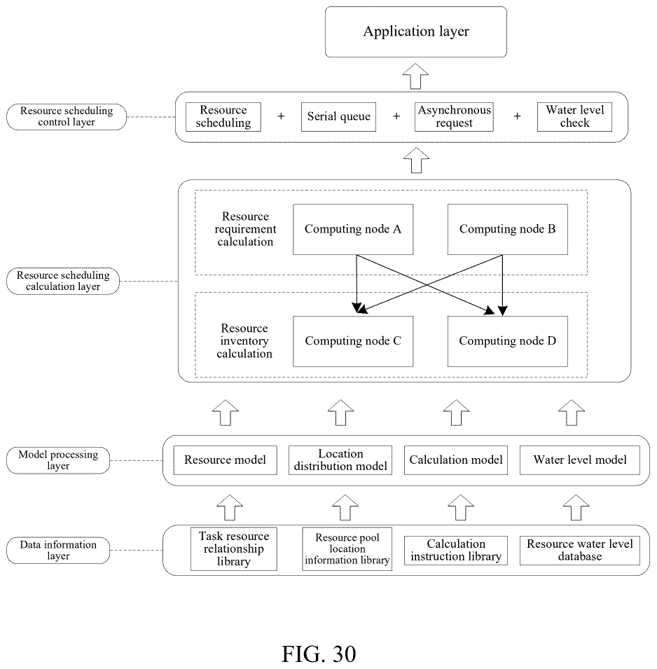

Referring to some embodiments of the present disclosure shown in FIG. 30, FIG. 30 shows a type of system architecture to which a resource scheduling method in the present disclosure is applied. The system architecture for resource scheduling shown in FIG. 30 includes a data information layer, a model processing layer, a resource scheduling calculation layer, a resource scheduling control layer, and an application layer. The following provides detailed descriptions of the layers:

The data information layer is used to store various types of data and information that need to be used in resource scheduling, which may include, but is not limited to a resource pool water level information library, a resource pool location information library, a task resource relationship library, and a calculation instruction library.

The model processing layer is used to extract data information on the data information layer and structure the data information, so that the resource scheduling calculation layer invokes the corresponding data information. The resource pool water level information library is structured into the water level model, the resource pool location information library is structured into the location distribution model, the task resource relationship library is structured into the resource model, and the calculation instruction library is structured into the calculation model.

The resource scheduling calculation layer is used to obtain requirement information from the resource scheduling control layer, and perform corresponding scheduling calculation under an indication of the requirement information. When calculation is performed on the resource scheduling calculation layer again, the corresponding data information is invoked from the resource scheduling calculation layer and is used as a basis of calculation. The resource scheduling calculation layer may be divided into two parts. One part is used to perform calculation on a resource requirement, and the other part is used to perform calculation on resource inventory. Resource scheduling is essentially a process of allocating the resource inventory to satisfy the resource requirement. Therefore, disassembling scheduling calculation of resource scheduling into two parts helps fully use computing power of the computing node.

The resource scheduling control layer may implement functions in various aspects such as resource scheduling, a serial queue, an asynchronous request, and water level checking. Resource scheduling means that the resource scheduling method in this embodiment of the present disclosure is used as control logic on the resource scheduling control layer, and specific implementation of the resource scheduling method needs to be implemented with reference to a computing capability of the resource scheduling calculation layer. The serial queue means that considering that different tasks may use the same resource in the same resource pool, if parallel resource scheduling is simultaneously performed on the tasks, resource competition may be caused, affecting the efficiency of resource scheduling. To this end, in this embodiment of the present disclosure, the plurality of tasks need to be placed in the task queue for queuing, and the tasks are taken out in the order from front to rear of the task queue, where the later task is taken out only after the previous task that is taken out is completely executed. The asynchronous operation means that execution logic of each part in this embodiment of the present disclosure may be implemented through the asynchronous operation after being decoupled. The water level check means that in this embodiment of the present disclosure, the resource inventory of the multi-level resource pool may be further detected on the resource scheduling control layer, to determine scheduling solutions of various types of resources and perform a supplementing operation on the multi-level resource pool.

Application layer. The embodiments of the present disclosure are applicable to a plurality of types of service scenarios. In different service scenarios, a task of resource scheduling that is needed may be delivered on the application layer in a resource scheduling system architecture.

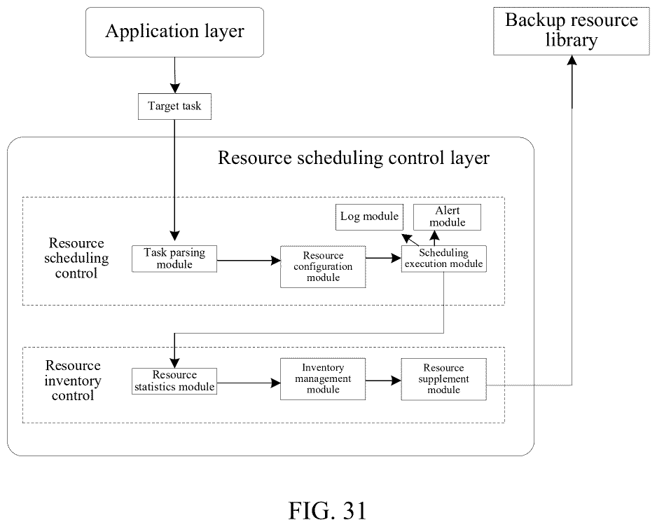

Referring to some embodiments of the present disclosure provided in FIG. 31; FIG. 31 is a diagram of an asynchronous operation according to an embodiment of the present disclosure. The asynchronous operation means that execution logic of each part in the embodiments of the present disclosure may be implemented through the asynchronous operation after being decoupled. In FIG. 31, logic decoupling is performed on various parts of the resource scheduling control layer, and the various parts of the resource scheduling control layer are decoupled into different modules. Details are as follows:

A task parsing module is configured to obtain, in response to a resource scheduling request of a target task, a plurality of candidate resource combinations corresponding to the target task, where each candidate resource combination includes at least one target resource needed by the target task and a target resource quantity of the target resource.

A resource configuration module is configured to search, for each candidate resource combination based on the at least one target resource and the target resource quantity, a multi-level resource pool in ascending order of levels, to determine seed resource pools corresponding to the candidate resource combinations; and further, determine, in the plurality of seed resource pools based on levels of the seed resource pools corresponding to the candidate resource combinations, a target resource pool used to satisfy the resource scheduling request.

A scheduling execution module is configured to perform resource scheduling after the target resource pool used to satisfy the resource scheduling request is determined.

A log module is configured to update, based on a performed resource scheduling operation, a computer log recording system operation information.

An alert module is configured to perform an alert operation when an emergency occurs in resource scheduling.

A resource statistics module is configured to be triggered after resource scheduling is performed, to update resource inventory information in the multi-level resource pool based on an scheduled resource.

An inventory management module may be configured to check whether inventory of the multi-level resource pool is relatively starved, that is, execution logic of water level check.

A resource supplementing module is configured to transmit a supplementing request to a backup resource library when the inventory of the multi-level resource pool is relatively starved, to supplement a resource to the multi-level resource pool.

Accordingly, the execution logic of the parts in this embodiment of the present disclosure may be implemented through the asynchronous operation after being decoupled, to clearly determine functions of modules in the resource scheduling process, and facilitate implementation of the resource scheduling method in this embodiment of the present disclosure.

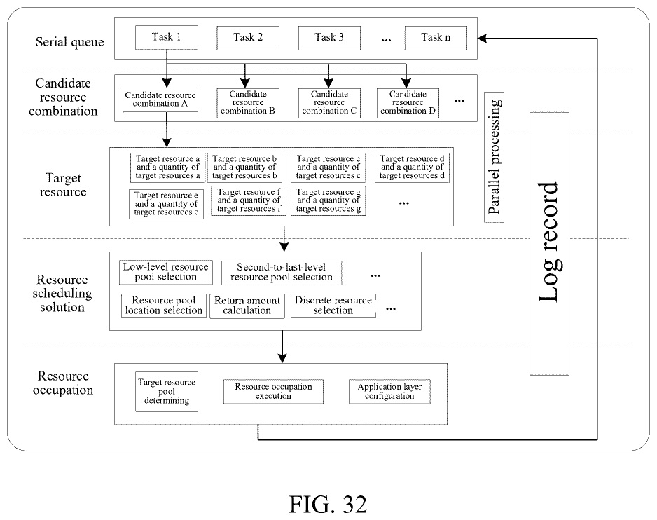

Referring to the embodiments of the present disclosure provided in FIG. 32, FIG. 32 shows some relatively specific examples of the resource scheduling method. The serial queue may include n tasks, which are respectively a task 1, a task 2, a task 3, . . . , and a task n.

To avoid competition between resource scheduling of different tasks, the n tasks are placed in the serial queue for resource scheduling in sequence. Each task specifically corresponds to several candidate matching combinations. The task 1 includes a plurality of candidate resource combinations such as a candidate resource combination A, a candidate resource combination B, a candidate resource combination C, and a candidate resource combination D. Each candidate resource combination specifically corresponds to several types of target resources. The candidate resource combination A includes a plurality of types of target resources, such as a target resource a, a target resource b, a target resource c, a target resource d, a target resource e, a target resource f, and a target resource g. A target resource of each candidate resource combination in the candidate combinations has a corresponding target resource quantity, which is used to indicate a quantity of target resources needed to satisfy the target task. A process of parsing out the target resource and the target resource quantity in the candidate resource combination from the target task may be processed in parallel, to improve calculation efficiency.

After the target resource and the target resource quantity of each candidate resource combination are clarified, a resource scheduling solution may be configured. For each candidate resource combination based on the at least one target resource and the target resource quantity, a seed resource pool is first selected from a low-level resource pool, a seed resource pool is then selected from a second-to-last resource pool, and the multi-level resource pool is searched in ascending order of levels in this manner, to determine seed resource pools corresponding to the candidate resource combinations. Further, a target resource pool used to satisfy the resource scheduling request is determined in the plurality of seed resource pools based on levels of the seed resource pools corresponding to the candidate resource combinations. Specifically, the target resource pool may be determined based on the location of the multi-level resource pool, that is, resource pool location selection. Alternatively, the target resource pool may be determined based on a corresponding return amount of the resource pool. Alternatively, the target resource pool may be determined based on the discrete resource quantity.

After the target resource pool is determined, resource occupation may be performed based on the target resource pool, to prevent a corresponding resource from being invoked by another task or process. Based on this, an occupied resource may be configured for the application layer, to complete resource scheduling. An entire process of parsing out the candidate resource combination from the target task until the resource is occupied and the resource is configured for the application layer may be recorded in log information. Accordingly, the efficiency of resource scheduling can be improved. The foregoing solution can be applied to various application scenarios, a target resource pool used to satisfy a resource scheduling request is properly determined, and therefore, flexibility of resource scheduling is high.

### Experiment Data Descriptions in the Embodiments of the Present Disclosure

In some embodiments, for a target task of filling a material gap of a device component at a place A, a conventional product number-based resource scheduling method is used to schedule a device component at another place to fill the material gap, and a resource scheduling method in this embodiment of the present disclosure is used to schedule the device component at the another place to fill the material gap.

To clarify a beneficial effect of the resource scheduling method in this embodiment of the present disclosure, in this embodiment of the present disclosure, resource scheduling indicators of two resource scheduling methods are compared, as shown in Table 1.

TABLE 1

| | Resource scheduling | |
|---|---|---|
| | | Resource scheduling |
| | Product number-based | method in an |
| | resource scheduling | embodiment of the |
| Indicator comparison | method | present disclosure |
| Scheduling solution matching speed | Hour level | Minute level and second |
| | | level |
| Whether to support region division | No | Yes |
| Whether a distance factor is | No | Yes |
| considered | | |
| Whether matching scheduling is | No | Yes |
| supported | | |
| Inbound/outbound efficiency | Two days/order | One day/order |

In the embodiments of the present disclosure, five types of resource scheduling indicators, namely, a matching speed, whether region division is supported, whether distance consideration is supported, whether matching scheduling is supported, and the inbound/outbound efficiency, of the two resource scheduling methods are specifically compared.

Regarding the resource scheduling indicator of the scheduling solution matching speed, the scheduling solution matching speed of the conventional product number-based resource scheduling method is of an hour level. However, a scheduling solution matching speed of the resource scheduling method in this embodiment of the present disclosure is of a minute level and a second level. It may be clarified that, the resource scheduling method in the embodiments of the present disclosure can improve the efficiency of resource scheduling. In some embodiments, when nationwide resource scheduling is performed on 500 C4 modules (a device component), the resource scheduling method in this embodiment of the present disclosure may increase a scheduling solution matching speed from two hours to 10 seconds, and matching efficiency is improved by approximately 99.86%.

Regarding the indicator of whether region division is supported, a region associated with the place A cannot be determined in the conventional product number-based resource scheduling method. Therefore, a storage warehouse in which device components are stored cannot be determined from the associated region. However, in the resource scheduling method in this embodiment of the present disclosure, based on the region associated with the place A, level division may be performed on the storage warehouses, and then storage warehouses of the multi-level resource pool are searched in ascending order of levels. It may be clarified that, in the resource scheduling method in this embodiment of the present disclosure, selection of a region in which the storage warehouse is located is highly correlated to a location of the material gap. Therefore, material gaps at different places may have different resource scheduling solutions, to improve the flexibility of resource scheduling.

Regarding whether distance consideration is supported, in the conventional product number-based resource scheduling method, a storage warehouse needed to provide a resource for scheduling cannot be determined based on a distance to the material gap at the place A. However, in the resource scheduling method in this embodiment of the present disclosure, level division may be performed on the storage warehouses based on the distance to the material gap at the place A, and then the storage warehouses of the multi-level resource pool are searched in the ascending order of the levels. Accordingly, a storage warehouse that is relatively close to the material gap can be determined, and the storage warehouse is used for resource scheduling, to reduce transportation overheads and improve the efficiency of resource scheduling.

Regarding whether matching scheduling is supported, the conventional product number-based resource scheduling method cannot support matching resource scheduling. Using resource scheduling of device components as an example, models of the components usually have matching correspondences, and if the models do not correspond to each other, it is difficult to assemble and use the components. Based on this, in the resource scheduling method in this embodiment of the present disclosure, a candidate resource combination corresponding to the material gap may be obtained, and then the storage warehouse is determined based on the candidate resource combination, so that matching resource scheduling can be implemented, to improve the efficiency of resource scheduling and the flexibility of resource scheduling.

Regarding the inbound/outbound efficiency, in the conventional product number-based resource scheduling method, generally, resource outbound and resource inbound of resource scheduling of one order can be completed within two days. However, in the resource scheduling method in this embodiment of the present disclosure, resource outbound and resource inbound of resource scheduling of one order may be completed within one day. It may be clarified that, the resource scheduling method in the embodiments of the present disclosure can improve the efficiency of resource scheduling.

### Descriptions of an Apparatus and a Device in the Embodiments of the Present Disclosure

Although the steps are displayed sequentially based on the indications of the arrows in the flowcharts, these steps are not necessarily performed sequentially in the sequence indicated by the arrows. Unless otherwise explicitly specified in the embodiments, execution of the operations is not strictly limited, and the operations may be performed in other sequences. Moreover, at least some of the operations in the flowchart may include a plurality of operations or a plurality of stages. The operations or stages are not necessarily performed at the same moment but may be performed at different moments. The operations or stages are not necessarily performed sequentially, but may be performed in turn or alternately with another operation or at least some of operations or stages of another operation.

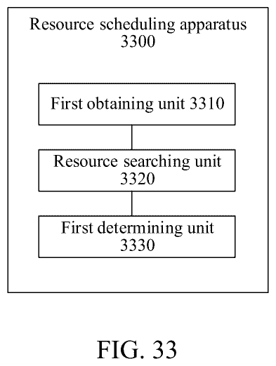

According to an aspect of the present disclosure, as shown in FIG. 33, a resource scheduling apparatus 3300 is provided. The resource scheduling apparatus 3300 may be configured in the foregoing resource scheduling server. The resource scheduling apparatus 3300 includes:
a first obtaining unit 3310, configured to obtain, in response to a resource scheduling request of a target task, a plurality of candidate resource combinations corresponding to the target task, each candidate resource combination including at least one target resource needed by the target task and a target resource quantity of the target resource;
a resource searching unit 3320, configured to search, for each candidate resource combination based on the at least one target resource and the target resource quantity, resource pools in a multi-level resource pool in ascending order based on preset levels in the multi-level resource pool, to determine seed resource pools corresponding to the candidate resource combinations; and
a first determining unit 3330, configured to determine, in the plurality of seed resource pools based on levels of the seed resource pools corresponding to the candidate resource combinations, a target resource pool used to satisfy the resource scheduling request.

In some embodiments, each storage resource pool in the multi-level resource pool includes various types of storage resources of various general types and resource quantities of the storage resources in the various general types; and
the resource searching unit 3320 is specifically configured to:
search, for each candidate resource combination based on the at least one target resource and the target resource quantity, the resource pools in the multi-level resource pool in the ascending order based on the preset levels in the multi-level resource pool, and if one resource pool to be checked in the multi-level resource pool is capable of being satisfied by a resource quantity in a single general type for the target resource quantity of the target resource, determine the seed resource pools in the resource pool to be checked.

In some embodiments, the resource searching unit 3320 is specifically configured to:
determine, if a quantity of resource pools to be checked is one, the resource pool to be checked as the seed resource pool; and
determine, if a quantity of resource pools to be checked is two or more, the seed resource pools based on levels of the two or more resource pools to be checked.

In some embodiments, the resource searching unit 3320 is specifically configured to:
determine, in the two or more resource pools to be checked, a resource pool to be checked having a low level as the seed resource pool if a quantity of resource pools to be checked is two or more;
if the quantity of resource pools to be checked is two or more, and levels of the two or more resource pools to be checked are the same, determine scheduling return amounts of the two or more resource pools to be checked, and determine the seed resource pools based on the scheduling return amounts; and
if the scheduling return amounts of the two or more resource pools to be checked are the same, determine the seed resource pools based on resource pool types of the two or more resource pools to be checked.

In some embodiments, the resource searching unit 3320 is specifically configured to:
obtain resource container capacities of a plurality of resource containers of the resource pools to be checked;
sort the plurality of resource containers in descending order based on volumes of the resource container capacities;
determine a resource container ranking top as a to-be-checked resource container, and determine the target resource quantity as an unscheduled resource quantity;
execute a first process, where the first process includes: performing a modulo operation on a remainder of a resource container capacity of the to-be-checked resource container and the unscheduled resource quantity, updating the unscheduled resource quantity, updating the to-be-checked resource container by using a next resource container in the sorting, and repeating the first process until the to-be-checked resource container is empty; and
determine the scheduling return amount based on the unscheduled resource quantity.

In some embodiments, the resource searching unit 3320 is specifically configured to:
obtain a discrete resource quantity of the resource pool to be checked;
determine that the scheduling return amount is 0 if the discrete resource quantity is greater than the unscheduled resource quantity; and
if the discrete resource quantity is not greater than the unscheduled resource quantity, subtract the unscheduled resource quantity from a resource container capacity of a resource container ranking bottom, to obtain the scheduling return amount.

In some embodiments, the resource searching unit 3320 is specifically further configured to:
if any storage resource pool in the multi-level resource pool cannot be satisfied by the resource quantity in the single general type for the target resource quantity of each type of target resource, select, from a storage resource pool having a lowest level, a storage resource pool having a smallest deficit quantity that is obtained after the target resource quantity is satisfied by the resource quantity in the single general type as a seed resource pool, use the single general type as a target general type, and use, as a remaining resource quantity, a resource quantity that is still not satisfied after the target resource quantity is satisfied by the resource quantity in the single general type; and
select, from another storage resource pool having the lowest level, another storage resource pool having the smallest deficit quantity that is obtained after the resource quantity in the target general type is used to satisfy the remaining resource quantity, as a seed resource pool, and update the remaining resource quantity by using a resource quantity that is still not satisfied after the resource quantity in the target general type is used to satisfy the remaining resource quantity, until the storage resource pool having the lowest level is traversed.

In some embodiments, the resource searching unit 3320 is specifically further configured to:
execute a second process, where the second process includes: if the storage resource pool having the lowest level is traversed and the remaining resource quantity is still not 0, use the second-to-last level as the target level, perform traversing in the storage resource pool of the target level, select, from the storage resource pool that is not traversed, the storage resource pool having the smallest deficit quantity that is obtained after the resource quantity in the target general type is used to satisfy the remaining resource quantity as the seed resource pool, update the remaining resource quantity by using the resource quantity that is still not satisfied after the resource quantity in the target general type is used to satisfy the remaining resource quantity, until the storage resource pool of the target level is traversed, update the target level by using the next level of the target level, and repeat the second process until the highest level is reached.

In some embodiments, the first determining unit 3330 is specifically configured to:
obtain, if each candidate resource combination corresponds to one seed resource pool, the levels of the seed resource pools corresponding to the candidate resource combinations; and
determine a seed resource pool having a lowest level in the seed resource pools corresponding to the candidate resource combinations as the target resource pool.

In some embodiments, the first determining unit 3330 is specifically configured to:
if a quantity of seed resource pools having a lowest level is two or more, determine scheduling return amounts of the two or more seed resource pools, and determine the target resource pool based on the scheduling return amounts; and
if the scheduling return amounts of the two or more seed resource pools are the same, determine the target resource pool based on resource pool types of the two or more seed resource pools.

In some embodiments, the first determining unit 3330 is further specifically configured to:
obtain, if one part of candidate resource combinations corresponds to the plurality of seed resource pools, a seed resource pool having a highest level in the plurality of seed resource pools as a selected seed resource pool, and use, for the other part of candidate resource combinations corresponding to a single seed resource pool, the single seed resource pool as the selected seed resource pool; and
determine a seed resource pool having a lowest level in the selected seed resource pools corresponding to the candidate resource combinations as the target resource pool.

In some embodiments, the resource scheduling apparatus 3300 further includes:
a task receiving unit (not shown in FIG. 33), configured to receive resource scheduling requests of a plurality of tasks, where the plurality of tasks include the target task;
a queue generation unit (not shown in FIG. 33), configured to place the plurality of tasks in a task queue for queuing; and
a task extraction unit (not shown in FIG. 33), configured to take out the tasks in an order from front to rear of the task queue, where a later task is taken out only after a previous task that is taken out is completely executed.

In some embodiments, the queue generation unit (not shown in FIG. 33) is specifically configured to:
determine a priority identifier of each of the plurality of tasks; and
arrange the plurality of tasks into the task queue based on the priority identifier.

In some embodiments, the resource scheduling apparatus 3300 further includes:
a second determining unit (not shown in FIG. 33), configured to determine a resource quantity of each type of resource needed by the plurality of tasks in the task queue;
a first calculation unit (not shown in FIG. 33), configured to: for each type of resource, sum the resource quantity of the type of resource needed by the plurality of tasks, to obtain a first total resource quantity of the type of resource;
a second calculation unit (not shown in FIG. 33), configured to sum a resource quantity of the type of resource in the multi-level resource pool, to obtain a second total resource quantity of the type of resource; and
a resource supplementing unit (not shown in FIG. 33), configured to transmit a supplementing request to a backup resource library if the first total resource quantity is greater than the second total resource quantity, to supplement a resource to the multi-level resource pool.

In some embodiments, the resource supplementing unit (not shown in FIG. 33) is specifically configured to:
determine a difference between the first total resource quantity and the second total resource quantity;
determine a supplementing resource quantity based on the difference and a predetermined multiple; and
transmit a supplementing request to a backup resource library based on the supplementing resource quantity, to supplement a resource of the supplementing resource quantity to the multi-level resource pool.

In some embodiments, the resource scheduling method is performed by a target computing node in a plurality of candidate computing nodes, and the target computing node is selected from the plurality of candidate computing nodes in the following manner:
obtaining processing capabilities of the plurality of candidate computing nodes;
obtaining allocated task quantities of the plurality of candidate computing nodes; and
selecting the target computing node from the plurality of candidate computing nodes based on the processing capabilities and the allocated task quantities.

In some embodiments, a quantity of candidate computing nodes is periodically changed in the following manner:
obtaining a total task quantity of a resource platform in a current period; and
determining the quantity of candidate computing nodes based on the total task quantity.

In some embodiments, the resource scheduling apparatus 3300 further includes:
a second obtaining unit, configured to obtain a resource pool water level information library, a resource pool location information library, a task resource relationship library, and a calculation instruction library;
a water level model construction unit (not shown in FIG. 33), configured to structure the resource pool water level information library into a water level model, structure the resource pool location information library into a location distribution model, structure the task resource relationship library into a resource model, and structure the calculation instruction library into a calculation model; and the first obtaining unit 3310 is specifically configured to:
invoke the resource model through the calculation model, and obtain, in response to the resource scheduling request, the plurality of candidate resource combinations corresponding to the target task;
the resource searching unit 3320 is specifically configured to:
determine locations of resource pools of various levels through the calculation model based on the location distribution model, and invoke the water level model, to determine the seed resource pools corresponding to the candidate resource combinations; and the first determining unit 3330 is specifically configured to:
determine, in the plurality of seed resource pools through the calculation model, the target resource pool used to satisfy the resource scheduling request.

In some embodiments, the resource searching unit 3320 is specifically configured to:
receive an invocation request for a target domain name of the water level model, where the target domain name is shared by a primary water level model and a secondary water level model;
forward the invocation request to the primary water level model for execution if the primary water level model runs normally; and
forward the invocation request to the secondary water level model for execution if the primary water level model is faulty.

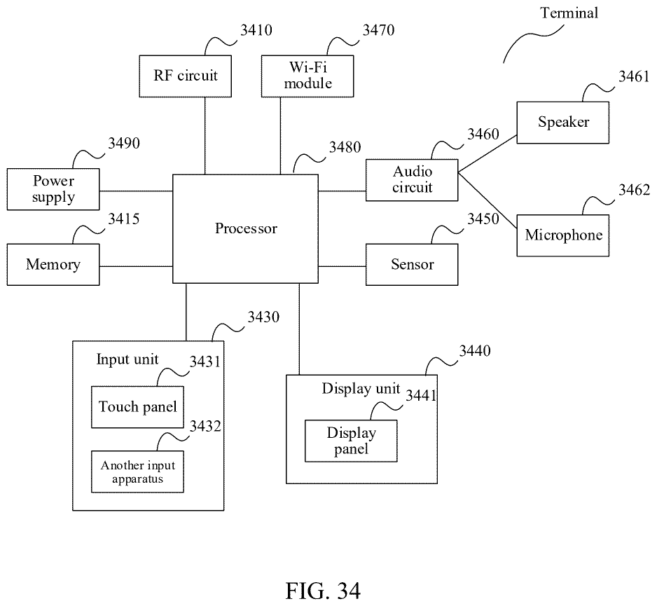

FIG. 34 is a structural block diagram of a part of a terminal 140 of implementing a resource scheduling method used for content recommendation according to an embodiment of the present disclosure. The terminal includes components such as a radio frequency (RF) circuit 3410, a memory 3415, an input unit 3430, a display unit 3440, a sensor 3450, an audio circuit 3460, a wireless fidelity (Wi-Fi) module 3470, a processor 3480, and a power supply 3490. A person skilled in the art may understand that the structure of the terminal shown in FIG. 34 does not constitute a limitation on the mobile phone or the computer, and the mobile phone or the computer may include more components or fewer components than those shown in the figure, or some components may be combined, or a different component deployment may be used.

The RF circuit 3410 may be configured to receive and transmit signals in an information receiving and transmitting process or a call process. Specifically, the RF circuit receives downlink information from a base station, then delivers the downlink information to the processor 3480 for processing, and transmits designed uplink data to the base station.

The memory 3415 may be configured to store a software program and a module, and the processor 3480 runs the software program and the module stored in the memory 3415, to perform various functional applications and data processing of the terminal.

The input unit 3430 may be configured to receive input digit or character information, and generate a key signal input related to settings and function control of the terminal. Specifically, the input unit 3430 may include a touch panel 3431 and other input apparatuses 3432.

The display unit 3440 may be configured to display input information or provided information and various menus of the terminal. The display unit 3440 may include a display panel 3441.

The audio circuit 3460, the speaker 3461, and the microphone 3462 may provide an audio interface.

In this embodiment, the processor 3480 included in the terminal may perform the resource scheduling method used for content recommendation in the foregoing embodiment.

The terminal in the embodiment of the present disclosure includes but is not limited to a mobile phone, a computer, an intelligent voice interaction device, a smart home appliance, a vehicle-mounted terminal, an aircraft, and the like. The embodiments of the present disclosure may be applied to various scenarios, including but not limited to artificial intelligence, big data, data processing, and the like.

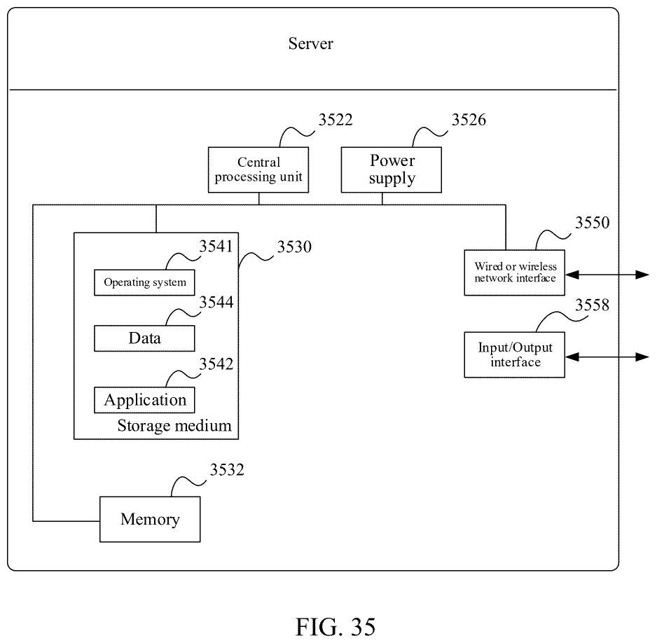

FIG. 35 is a structural block diagram of a part of a server of implementing a resource scheduling method used for content recommendation according to an embodiment of the present disclosure. The server 110 may vary greatly due to different configurations or performance, and may include one or more central processing units (CPUs) 3522 (for example, one or more processors), a memory 3532, and one or more storage mediums 3530 (for example, one or more mass storage apparatuses) that store applications 3542 or data 3544. The memory 3532 and the storage medium 3530 may be transient storage or persistent storage. A program stored in the storage medium 3530 may include one or more modules (not marked in the figure), and each module may include a series of instruction operations on the server 3500. Further, the central processing unit 3522 may be set to communicate with the storage medium 3530, and execute, on the server 3500, the series of instruction operations stored in the storage medium 3530.

The server 3500 may further include one or more power supplies 3526, one or more wired or wireless network interfaces 3550, one or more input/output interfaces 3558, and/or one or more operating systems 3541, such as Windows Server™, Mac OS X™, Unix™, Linux™, and FreeBSD™.

The processor in the server 3500 may be configured to perform the resource scheduling method used for content recommendation provided in the embodiments of the present disclosure.

An embodiment of the present disclosure further provides a computer-readable storage medium, where the computer-readable storage medium is configured to store a computer program, and the computer program is configured to perform the resource scheduling method according to each of the foregoing embodiments.

An embodiment of the present disclosure further provides a computer program product, including a computer program. A processor of a computer device reads and executes the computer program, to enable the computer device to perform the resource scheduling method.

The terms “first”, “second”, “third”, “fourth”, and the like (if any) in the descriptions of the present disclosure and the accompanying drawings are used to distinguish similar objects, but are not necessarily used to describe specific sequence or sequential order. The data used in such a way are interchangeable in proper circumstances so that the embodiments of the present disclosure described herein can be implemented in orders except the order illustrated or described herein. In addition, terms “comprise”, “include”, and any variations are intended to cover non-exclusive inclusions. For example, processes, methods, systems, products, or apparatuses that include a series of operations or units are not necessarily limited to those operations or units clearly listed, but can include other operations or units not explicitly listed or inherent to these processes, methods, products, or apparatuses.

In the present disclosure, “at least one (item)” means one or more, and “plurality” means two or more. The term “and/or” describes an association between associated objects and represents that three associations may exist. For example, “A and/or B” may indicate that only A exists, only B exists, and both A and B exist, where A and B may be singular or plural. A character “/” generally indicates an “or” relationship between the associated objects. The phrase “at least one of the following items (pieces)” or its similar expression indicates any combination of these items, including any combination of single items (pieces) or plural items (pieces). For example, at least one of a, b, or c may represent a, b, c, “a and b”, “a and c”, “b and c”, or “a, b, and c”, where a, b, and c may be singular or plural.

In the descriptions of the embodiments of the present disclosure, a plurality of (or a plurality of) means two or more. Greater than, less than, more than, and the like are understood as excluding this number, and above, below, within, and the like are understood as including this number.

In the several embodiments provided by the present disclosure, the system, the apparatus and the method disclosed can be implemented in other manners. For example, the described apparatus embodiment is merely an example. For example, division into the units is merely logical function division and may be other division in specific implementations. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, in other words, may be located in one location, or may be distributed on a plurality of network units. Some or all of the units may be selected based on specific requirements to achieve the objectives of the solutions of embodiments.

In addition, functional units in the embodiments of the present disclosure may be integrated into one processing unit, or each of the units may be physically separated, or two or more units may be integrated into one unit. The integrated unit may be implemented in a form of hardware, or may be implemented in a form of a software functional unit.

When the integrated unit is implemented in the form of the software function unit and sold or used as an independent product, the integrated unit may be stored in a computer-readable storage medium. Based on such understanding, the technical solution of the present disclosure can be embodied in the form of software products in essence or part that contributes to the related art or in entirety or part, the computer software products are stored in the storage medium, and include several instructions to make one computer apparatus (a personal computer, a server, a network device, and the like) perform all or some operations of the method of the examples of the present disclosure. The foregoing storage medium includes: any medium that can store a computer program, such as a USB flash drive, a removable hard disk, a read-only memory (ROM), a random access memory (RAM), a magnetic disk, or an optical disk.

Various implementations according to the embodiments of the present disclosure can be combined in different manners to form other embodiments to achieve different technical effects.

The detailed descriptions provided above are particular descriptions of the implementations of the present disclosure, but the present disclosure is not limited to the implementations described above. A person skilled in the art can make various equivalent variations or substitutions without violating the spirit conditions of the present disclosure, and these equivalent variations or substitutions are to fall within the scope defined by the claims of the present disclosure.

What is claimed is:

1. A resource scheduling method, performed by a resource scheduling server, the method comprising:
obtaining a plurality of candidate resource combinations corresponding to the target task in response to a resource scheduling request of a target task, each candidate resource combination comprising at least one target resource needed by the target task and a target resource quantity of the target resource;
searching resource pools in a multi-level resource pool in ascending order based on preset levels in the multi-level resource pool to determine seed resource pools corresponding to the candidate resource combinations for each candidate resource combination based on the at least one target resource and the target resource quantity; and
determining a target resource pool used to satisfy the resource scheduling request in the plurality of seed resource pools based on levels of the seed resource pools corresponding to the candidate resource combinations.

2. The resource scheduling method according to claim 1, wherein each storage resource pool in the multi-level resource pool comprises various storage resources of various general types and resource quantities of the storage resources in the various general types; and
the searching resource pools in a multi-level resource pool in ascending order based on preset levels in the multi-level resource pool to determine seed resource pools corresponding to the candidate resource combinations for each candidate resource combination based on the at least one target resource and the target resource quantity comprises:
searching the resource pools in the multi-level resource pool in the ascending order based on the preset levels in the multi-level resource pool for each candidate resource combination based on the at least one target resource and the target resource quantity, and if one resource pool to be checked in the multi-level resource pool is capable of being satisfied by a resource quantity in a single general type for the target resource quantity of the target resource, determining the seed resource pools in the resource pool to be checked.

3. The resource scheduling method according to claim 2, wherein the determining the seed resource pools in the resource pool to be checked comprises:
determining, if a quantity of resource pools to be checked is one, the resource pool to be checked as the seed resource pool; and
determining, if a quantity of resource pools to be checked is two or more, the seed resource pools based on levels of the two or more resource pools to be checked.

4. The resource scheduling method according to claim 3, wherein the determining, if a quantity of resource pools to be checked is two or more, the seed resource pools based on levels of the two or more resource pools to be checked comprises:
determining a resource pool to be checked having a low level as the seed resource pool if a quantity of resource pools to be checked is two or more in the two or more resource pools to be checked;
if the quantity of resource pools to be checked is two or more, and levels of the two or more resource pools to be checked are the same, determining scheduling return amounts of the two or more resource pools to be checked, and determining the seed resource pools based on the scheduling return amount; and
if the scheduling return amounts of the two or more resource pools to be checked are the same, determining the seed resource pools based on resource pool types of the two or more resource pools to be checked.

5. The resource scheduling method according to claim 4, wherein the determining scheduling return amounts of the two or more resource pools to be checked comprises:
obtaining resource container capacities of a plurality of resource containers of the resource pools to be checked;
sorting the plurality of resource containers in descending order based on volumes of the resource container capacities;
determining a resource container ranking top as a to-be-checked resource container, and determining the target resource quantity as an unscheduled resource quantity;
executing a first process, wherein the first process comprises: performing a modulo operation on a remainder of a resource container capacity of the to-be-checked resource container and the unscheduled resource quantity, updating the unscheduled resource quantity, updating the to-be-checked resource container by using a next resource container in the sorting, and repeating the first process until the to-be-checked resource container is empty; and
determining the scheduling return amount based on the unscheduled resource quantity.

6. The resource scheduling method according to claim 5, wherein the determining the scheduling return amounts based on the unscheduled resource quantity comprises:
obtaining a discrete resource quantity of the resource pool to be checked;
determining that the scheduling return amount is 0 if the discrete resource quantity is greater than the unscheduled resource quantity; and
if the discrete resource quantity is not greater than the unscheduled resource quantity, subtracting the unscheduled resource quantity from a resource container capacity of a resource container ranking bottom, to obtain the scheduling return amount.

7. The resource scheduling method according to claim 1, wherein the determining a target resource pool used to satisfy the resource scheduling request in the plurality of seed resource pools based on levels of the seed resource pools corresponding to the candidate resource combinations comprises:
obtaining the levels of the seed resource pools corresponding to the candidate resource combinations if each candidate resource combination corresponds to one seed resource pool; and
determining a seed resource pool having a lowest level in the seed resource pools corresponding to the candidate resource combinations as the target resource pool.

8. The resource scheduling method according to claim 7, wherein the determining a seed resource pool having a lowest level in the seed resource pools corresponding to the candidate resource combinations as the target resource pool comprises:
if a quantity of seed resource pools having the lowest level is two or more, determining scheduling return amounts of the two or more seed resource pools, and determining the target resource pool based on the scheduling return amounts; and
if the scheduling return amounts of the two or more seed resource pools are the same, determining the target resource pool based on resource pool types of the two or more seed resource pools.

9. The resource scheduling method according to claim 1, wherein the determining a target resource pool used to satisfy the resource scheduling request in the plurality of seed resource pools based on levels of the seed resource pools corresponding to the candidate resource combinations, further comprises:
obtaining a seed resource pool having a highest level in the plurality of seed resource pools as a selected seed resource pool if one part of candidate resource combinations corresponds to the plurality of seed resource pools, and using the single seed resource pool as the selected seed resource pool for the other part of candidate resource combinations corresponding to a single seed resource pool; and
determining a seed resource pool having a lowest level in the selected seed resource pools corresponding to the candidate resource combinations as the target resource pool.

10. The resource scheduling method according to claim 1, wherein before the obtaining plurality of candidate resource combinations corresponding to the target task in response to a resource scheduling request of a target task, the resource scheduling method further comprises:
receiving resource scheduling requests of a plurality of tasks, wherein the plurality of tasks comprise the target task;
placing the plurality of tasks in a task queue for queuing; and
taking out the tasks in an order from front to rear of the task queue, wherein a later task is taken out only after a previous task that is taken out is completely executed.

11. The resource scheduling method according to claim 10, wherein the placing the plurality of tasks in a task queue for queuing comprises:
determining a priority identifier of each of the plurality of tasks; and
arranging the plurality of tasks into the task queue based on the priority identifier.

12. The resource scheduling method according to claim 10, wherein after the placing the plurality of tasks in a task queue for queuing, the resource scheduling method further comprises:
determining a resource quantity of each type of resource needed by the plurality of tasks in the task queue;
for each type of resource, summing the resource quantity of the type of resource needed by the plurality of tasks, to obtain a first total resource quantity of the type of resource;
summing a resource quantity of the type of resource in the multi-level resource pool, to obtain a second total resource quantity of the type of resource; and
transmitting a supplementing request to a backup resource library if the first total resource quantity is greater than the second total resource quantity, to supplement a resource to the multi-level resource pool.

13. The resource scheduling method according to claim 1, wherein the resource scheduling method is performed by a target computing node in a plurality of candidate computing nodes, and the target computing node is selected from the plurality of candidate computing nodes in the following manner:
obtaining processing capabilities of the plurality of candidate computing nodes;
obtaining allocated task quantities of the plurality of candidate computing nodes; and
selecting the target computing node from the plurality of candidate computing nodes based on the processing capabilities and the allocated task quantities.

14. The resource scheduling method according to claim 13, wherein the target computing node comprises a primary target computing node and a secondary target computing node, and the plurality of candidate computing nodes comprise a first group of candidate computing nodes and a second group of candidate computing nodes; and
the selecting the target computing node from the plurality of candidate computing nodes based on the processing capabilities and the allocated task quantities comprises:
determining the primary target computing node from the first group of candidate computing nodes based on the processing capabilities and the allocated task quantities, and determining the secondary target computing node from the second group of candidate computing nodes.

15. The resource scheduling method according to claim 13, wherein a quantity of candidate computing nodes is periodically changed in the following manner:
obtaining a total task quantity of a resource platform in a current period; and
determining the quantity of candidate computing nodes based on the total task quantity.

16. The resource scheduling method according to claim 1, wherein before the obtaining, in response to a resource scheduling request of a target task, a plurality of candidate resource combinations corresponding to the target task, the resource scheduling method further comprises:
obtaining a resource pool water level information library, a resource pool location information library, a task resource relationship library, and a calculation instruction library;
structuring the resource pool water level information library into a water level model, structuring the resource pool location information library into a location distribution model, structuring the task resource relationship library into a resource model, and structuring the calculation instruction library into a calculation model; and
the obtaining a plurality of candidate resource combinations corresponding to the target task in response to a resource scheduling request of a target task comprises:
invoking the resource model through the calculation model, and obtaining the plurality of candidate resource combinations corresponding to the target task in response to the resource scheduling request;
the searching the multi-level resource pool in the ascending order comprises:
determining locations of resource pools of various levels through the calculation model based on the location distribution model, and invoking the water level model, to determine the seed resource pools corresponding to the candidate resource combinations; and
the determining a target resource pool used to satisfy the resource scheduling request in the plurality of seed resource pools comprises:
determining the target resource pool used to satisfy the resource scheduling request in the plurality of seed resource pools through the calculation model.

17. An electronic device, comprising a memory and a processor, the memory having a computer program stored therein, and the processor, when executing the computer program, implementing the resource scheduling method comprising:
obtaining a plurality of candidate resource combinations corresponding to the target task in response to a resource scheduling request of a target task, each candidate resource combination comprising at least one target resource needed by the target task and a target resource quantity of the target resource;
searching resource pools in a multi-level resource pool in ascending order based on preset levels in the multi-level resource pool to determine seed resource pools corresponding to the candidate resource combinations for each candidate resource combination based on the at least one target resource and the target resource quantity; and
determining a target resource pool used to satisfy the resource scheduling request in the plurality of seed resource pools based on levels of the seed resource pools corresponding to the candidate resource combinations.

18. The electronic device according to claim 17, wherein each storage resource pool in the multi-level resource pool comprises various storage resources of various general types and resource quantities of the storage resources in the various general types; and
the searching resource pools in a multi-level resource pool in ascending order based on preset levels in the multi-level resource pool to determine seed resource pools corresponding to the candidate resource combinations for each candidate resource combination based on the at least one target resource and the target resource quantity comprise:
searching the resource pools in the multi-level resource pool in the ascending order based on the preset levels in the multi-level resource pool for each candidate resource combination based on the at least one target resource and the target resource quantity, and if one resource pool to be checked in the multi-level resource pool is capable of being satisfied by a resource quantity in a single general type for the target resource quantity of the target resource, determining the seed resource pools in the resource pool to be checked.

19. A non-transitory computer-readable storage medium, having a computer program stored therein, the computer program, when executed by a processor, implementing a resource scheduling method comprising:
obtaining a plurality of candidate resource combinations corresponding to the target task in response to a resource scheduling request of a target task, each candidate resource combination comprising at least one target resource needed by the target task and a target resource quantity of the target resource;
searching resource pools in a multi-level resource pool in ascending order based on preset levels in the multi-level resource pool to determine seed resource pools corresponding to the candidate resource combinations for each candidate resource combination based on the at least one target resource and the target resource quantity; and
determining a target resource pool used to satisfy the resource scheduling request in the plurality of seed resource pools based on levels of the seed resource pools corresponding to the candidate resource combinations.

20. The computer-readable storage medium according to claim 19, wherein each storage resource pool in the multi-level resource pool comprises various storage resources of various general types and resource quantities of the storage resources in the various general types; and
the searching resource pools in a multi-level resource pool in ascending order based on preset levels in the multi-level resource pool to determine seed resource pools corresponding to the candidate resource combinations for each candidate resource combination based on the at least one target resource and the target resource quantity comprise:
searching the resource pools in the multi-level resource pool in the ascending order based on the preset levels in the multi-level resource pool for each candidate resource combination based on the at least one target resource and the target resource quantity, and if one resource pool to be checked in the multi-level resource pool is capable of being satisfied by a resource quantity in a single general type for the target resource quantity of the target resource, determining the seed resource pools in the resource pool to be checked.
